(19) United States
(12) Patent Application Publication
(10) Pub. No.: US 2012/0049102 A1
(43) Pub. Date: Mar. 1, 2012

(54) AQUEOUS ELETRODEPOSITION OF MAGNETIC SAMARIUM-COBALT ALLOYS

(76) Inventors: Ken Nobe, Pacific Palisades, CA (US); Jen-Chieh Wei, Taipei (TW); Morton Schwartz, Los Angeles, CA (US)

(21) Appl. No.: 13/221,820

(22) Filed: Aug. 30, 2011

Related U.S. Application Data
(63) Continuation of application No. 11/872,699, filed on Oct. 15, 2007, now abandoned.
(60) Provisional application No. 60/851,389, filed on Oct. 13, 2006.
(60) Provisional application No. 60/852,286, filed on Oct. 17, 2006.

(51) Int. Cl. H01F 1/055; C25D 3/56; C22C 19/07

(52) U.S. Cl. 252/62.55; 420/435; 205/255

(57) ABSTRACT

Disclosed are methods and compositions for aqueous electrodeposition of rare earth-transitional metal alloys comprising samarium-cobalt. Also disclosed are nanostructured magnetic coatings comprising a magnetic alloy of a rare earth metal, namely samarium, and a transition metal, namely cobalt.

### CROSS-REFERENCE TO RELATED APPLICATIONS

This application is a continuation of U.S. application Ser. No. 11/872,699, filed Oct. 15, 2007, now abandoned, which claims the benefit of U.S. Application No. 60/851,389, filed Oct. 13, 2006, and U.S. Application No. 60/852,286, filed Oct. 17, 2006, which are hereby incorporated herein by reference in their entireties.

### ACKNOWLEDGEMENT

This invention was supported in part by the DARPA MEMS program (DABT 63-99-1-0020) and National Science Foundation Grant No. DMI-0089095. The United States government has certain rights in the invention.

### BACKGROUND

Bulk alloys of transition metals-rare earths, such as Nd—Fe—B and Sm—Co, are important permanent magnet materials. When using conventional techniques, however, the current high materials and processing costs of Sm—Co permanent magnets have limited their application to high temperature and corrosive environments where costs are of secondary importance. More specifically, only high cost metallurgical and physical deposition methods are currently in use to fabricate Sm—Co permanent magnets consisting of the intermetallics SmCo₅ and Sm₂Co₁₇.

In contrast, compositions and methods disclosed in U.S. Pat. No. 6,306,276 established the basis for the successful electrodeposition of rare earth-transition metal alloys from aqueous media. Suitable operating and plating bath conditions to obtain magnetic samarium-cobalt (Sm—Co) alloys from aqueous media for high performance nanostructured permanent magnets, however, have remained unknown in the art.

As current estimates of the global market for permanent magnets exceed $15 billion, such suitable operating and plating bath conditions to obtain magnetic samarium-cobalt (Sm—Co) alloys can provide substantial savings in manufacturing costs and considerable lower materials costs for nanotechnology applications, thereby greatly expanding the global market share of high performance Sm—Co permanent magnets fabricated by electrodeposition from aqueous media.

### SUMMARY

As embodied and broadly described herein, the invention, in one aspect, relates to an electrodeposition process for preparing high samarium content Sm—Co materials and Sm—Co magnets prepared by the process.

Disclosed are compositions for enhancing the aqueous electrodeposition of rare earth-transition metal alloys comprising a water soluble salt of samarium, a water soluble salt of cobalt, and a complexant.

Also disclosed are methods for electrodepositing a samarium-cobalt coating onto a conducting (e.g., metal) substrate, comprising placing an aqueous solution containing a water soluble salt of samarium, a water soluble salt of cobalt, optionally one or more supporting electrolytes, and a complexant into a plating bath, placing an anode and the substrate to be coated into the bath and connecting the anode and the substrate to a power supply, with the substrate acting as a cathode, adjusting the pH of the bath to a suitable operating level, and applying a current through the anode and substrate causing the samarium and the cobalt to deposit on, and adhere to, the substrate.

Also disclosed are samarium-cobalt coatings produced by the disclosed methods.

Also disclosed are nanostructured magnetic coatings comprising a magnetic alloy of a rare earth metal and a transition metal.

Unless otherwise expressly stated, it is in no way intended that any method or aspect set forth herein be construed as requiring that its steps be performed in a specific order. Accordingly, where a disclosed method or system does not specifically state that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIGS. 1(a)-(c) show Hull cell patterns obtained from bath 1 (1M Sm sulfamate, 0.05M Co sulfate, 0.15M glycine, pH6) at (a) 25° C., (b) 60° C. and (c) 80° C.

FIG. 2 shows XRD patterns of deposits obtained from bath 1 at 25° C. and (a) 50 mA/cm², metallic region; (b) 100 mA/cm², burnt region; and (c) 500 mA/cm², oxide/hydroxide region.

FIGS. 3(a)-(f) show Hull cell patterns obtained from bath 1, bath 2 (1M Sm sulfamate, 0.05M Co sulfate), and bath 3 (1M Sm sulfamate, 0.05M Co sulfate, 3M glycine) at (a)-(c) 25° C. and (d)-(f) 60° C.

FIG. 4 shows Sm deposit content obtained from plating baths 1 -3 containing glycine.

FIGS. 5(a) and (b) show the effect of current density and solution temperature on (a) samarium deposit content and (b) current efficiency.

FIG. 6 shows XRD patterns of deposits obtained from bath 1 at 25° C. and various CDs.

FIG. 7 shows XRD patterns of deposits obtained from bath 1 at 60° C. and various CDs.

FIGS. 8(a)-(c) show XRD patterns of deposits obtained from bath 1 at (a) 2 mA/cm², (b) 25 mA/cm² and (c) 50 mA/cm² at various solution temperatures.

FIGS. 9(a)-(i) show SEM images of Sm—Co thin films obtained from bath 1 at 25° C. and at 2 mA/cm² [(a)-(c)], 25 mA/cm² [(d)-(0] and 50 mA/cm² [(g)-(i)].

FIGS. 10(a)-(o) show SEM images of Sm—Co thin films obtained from bath 1 at 60° C. and at 25 mA/cm² [(a)-(c)], 50 mA/cm² [(d)-(f)], 100 mA/cm² [(g)-(i)], 300 mA/cm² [(j)-(l)] and 500 mA/cm² [(m)-(o)].

FIG. 11(a)-(i) show magnetic hysteresis loops obtained at 25° C. (graphs a-c) and 60° C. (graphs d-i) and at various CDs from bath 1.

FIGS. 12(a)-(d) show effects of current density and temperature on deposit crystalline structures, particle sizes and magnetic properties.

FIGS. 13(a) and (b) show the effect of glycine concentration on samarium deposit content and current efficiency.

FIG. 14 shows the effect of NH₄ sulfamate concentration on (a) samarium deposit content and (b) current efficiency at 25 and 60° C.

FIG. 15 shows the effect of peak current density and solution temperature on (a) samarium deposit content and (b) current efficiency for DC and PC (Tₒₙ=0.1 ms, γ=0.1) electrodeposition.

FIG. 16 shows XRD patterns of deposits obtained from bath 1 at 25 and 60° C. and various PCDs.

FIG. 17 shows magnetic hysteresis loops obtained at 25° C. (graphs a-c) and 60° C. (graphs d-h) and at various PCDs from bath 1.

FIG. 18 shows effects of peak current density and temperature on magnetic properties.

FIG. 19 shows the effects of duty cycles on magnetic properties.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included herein.

The present compounds, compositions, articles, systems, devices, and/or methods disclosed and described, are not limited to specific synthetic methods unless otherwise specified, or to particular reagents unless otherwise specified, and as such may, of course, vary. It is also to be understood that the terminology used herein is for the purpose of describing particular aspects only and is not intended to be limiting. While methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein may be different from the actual publication dates, which actual publication dates need to be independently confirmed.

### A. Definitions

As used in the specification and the appended claims, the singular forms “a,” “an” and “the” include plural referents unless the context clearly dictates otherwise. Thus, for example, reference to “a substrate,” “an alloy,” or “a sample” includes mixtures of two or more such substrates, alloys, or samples, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where the event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc., of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Rare Earth-Transition Metal (RE-TM) Permanent Magnets

RE-TM permanent magnets were developed in the 1960′s and became a practical commercial product in 1970. At that time, the RE-TM permanent magnets offered ten times higher coercivity and five times greater energy density than the best magnets of the 1960′s. The maximum energy products for the hard permanent magnets SmCo₅, Sm₂Co₁₇ and Nd₂Fe₁₄B are 175,210 and 240 kJ/m³ respectively [G. J. Long and F. Grandjean, Supermagnets, Hard Magnetic Materials, Kluwer Academic Publishers, Norwell, Mass., (1991), p 2.].

RE-TM permanent magnets of different compositions exhibit a wide range of magnetic properties and cost; the research and development of Sm—Co and Nd—Fe—B alloys got more attention among these magnets because of their superior performance and practical applications [K. J. Stmat, IEEE Trans. Magnetics, Mag-23, 2094, (1987).]. The first practical RE-TM permanent magnet, sintered SmCo₅, was available about 1970 in the U.S. [M. G. Benz and D. L. Martin, Appl. Phys. Letters, 17, 176, (1970).]. Right after SmCo₅, the investigation of quasi-binary intermetallics, RE₂(Co, Fe)₁₇ [A. E. Ray and K. J. Strnat, IEEE Trans. Magnetics, Mag-8, 516, (1972); K. J. Strnat, IEEE Trans. Magnetics, Mag-8, 511, (1972).], led to the development of the second generation of RE-IG permanent magnets—Sm₂Co₁₇. The first useful Sm₂Co₁₇ was developed in Japan in 1975 [T. Ojima, S. Tomizawa, T. Yoneyama, and T. Hori, Japan. J. Appl. Phys., 16, 671, (1977).]. The third generation of RE-TM permanent magnets, Nd₂Fe₁₄B, was developed by US and Japanese researchers and announced in 1983 [7; J. J. Croat, J. F. Herbst, R. W. Lee and F. E. Pinkerton, J. Appl. Phys., 55, 2078, (1984); M. Sagawa, S. Fujimura, N. Togawa, H. Yamamoto and Y. Matsuura, J. Appl. Phys., 55, 2083, (1984).] and brought new, much higher energy permanent magnets and a promise for cheaper RE-TM permanent magnets. The development of RE-TM permanent magnets not only resulted in a breakthrough of high performance magnetic materials but also created new applications for ferromagnetism materials.

Driven by the increasing interest in high performance permanent magnets, the improvement of RE-TM magnets has been mainly accomplished by the incorporation and substitution of specific elements to RE-TM alloys. For example, a small substitution of Cu for Co in SmCo₅ leads to the precipitation of a nonmagnetic phase which increased the coercivity [E. A. Nesbitt, R. H. Willens, R. C. Sherwood, E. Buehler, and J. H. Wernick, Appl. Phys. Letters, 12, 361, (1968).], the replacement of parts of Co by Fe in Sm₂Co₁₇ resulted in greater magnetization saturation (Ms) [A. E. Ray and K. J. Strnat, IEEE Trans. Magnetics, Mag-8, 516, (1972).] and the replacement of 50% of Fe by Co in Nd₂Fe₁₄B gives higher Curie temperature [R. Grossinger, R. Krewenka, H. Buchner, and H. Harada, J. Phys. (Paris), 49, C8-659, (1988).]. These improvements make RE-TM permanent magnets easier to use for different kinds of industrial applications (Table 1) and enhances the performance of these magnetic devices.

Except for the traditional ways of making RE-TM magnets (i.e., bonding and sintering [M. G. Benz and D. L. Martin, Appl. Phys. Letters, 17, 176, (1970); M. G. Benz and D. L. Martin, J. Appl. Phys., 43, 4733, (1972); A. E. Ray and K. J. Strnat, IEEE Trans. Magnetics, Mag-11, 1429, (1975).]), new manufacture methods (i.e. mechanical alloying [J. Wecker, M. Katter and L. Schultz, J. Appl. Phys., 69, 6085, (1991); J. Ding, P. G. McCormick and R. Street, J. Alloys Comp., 191, 197, (1993).], nano powder metallurgy [J. Ding, Y. Liu, P. G. McCormick and R. Street, J. Magn. Magn. Mater., 123, L239, (1993).], and thin film processes—DC sputtering [H. C. Theuerer, E. A. Nesbitt, and D. D. Bacon, J. Appl. Phys., 40, 2994, (1969); S. A. Bendson and J. H. Judy, IEEE Trans. Magnetics, 9, 627, (1973); C. Zhang, R. Liu and G. Feng, IEEE Trans. Magnetics, 16, 1215, (1980); H. S. Cho, J. R. Salem, A. J. Kellock and R. B. Beyers, IEEE Trans. Magnetics, 33, 2890, (1997); R. Andreescu and M. J. O'Shea, I Appl. Phys., 91, 8183, (2002); 22], Rf sputtering [V. Neua and S. A. Shaheen, J. Appl. Phys., 53, 2401, (1982); F. J. Cadieu, S. H. Aly and T. D. Cheung, J. Appl. Phys., 64, 5501, (1988); K. Chen, H. Hegde and F. J. Cadieu, Appl. Phys. Letters, 61, 1861, (1992); T. Numata, H. Kinyama and S. Inokuchi, Appl. Phys., 86, 7006, (1999).], PVD [V. Geiss, E. Kneller and A. Nest, Appl. Phys., A27, 79, (1982); M. Gronau, H. Goeke, D. Schaffler and S. Sprenger, IEEE Trans. Magnetics, Mag-19, 1653, (1983); U. Kullmann, E. Koester and C. Dorsch, IEEE Trans. Magnetics, Mag-20, 420, (1984).], and pulsed laser deposition [V. Neu, J. Thomas, S. Faller, B. Holzapfel and L. Schultz, J. Magn. Magn. Mater., 242-245, 1290, (2002); F. J. Cadieu, R. Rani, and T. Theodoropoulos and Li Chen, J. Appl. Phys., 85, 5895, (1999).]) have been studied and developed. The improvement of manufacturing process not only promotes these high performance devices for traditional applications (i.e., automotive, domestic, electronic, aerospace devices) but also for new industrial applications, such as information storage, micro-electromechanical systems (MEMS), and nano-electromechanical systems (NEMS) of thin film RE-TM magnets.

TABLE 1
Applications of permanent magnets*

| Application | Magnetic Devices and Products |
|---|---|
| Automotive | dc motor drivers, starter motors, window winders, |
| | wipers, fans, speed meters, alternators |
| Domestic | analogues, watches, video recorders, electric |
| | clocks, hearing aids, loudspeakers |
| Electronic and | sensors, contactless switches, nmr spectrometers, |
| Instrumentation | energy meter bearing, transducers, computer printer |
| | head, damper |
| Aerospace | frictionless bearings, couplings, magnetrons, klystrons, |
| | auto compasses |
| Biosurgical | dentures, magnetic sphincters, magnetic sutures, cancer |
| | cell separators, artifical hearts |
| Information | magneto-optical recording medium, perpendicular |
| storage | recording media, |
| MEMS & | micromotor, actuator, magnetometer, magnetic sensors, |
| NEMS | magnetic bubble memory |

*D. Howe, Ch. 24, ″ G. J. Long and F. Grandjean, Supermagnets, Hard Magnetic Materials, Kluwer Academic Publishers, Norwell, MA

Recent developments of RE-TM magnets have focused on Sm—Co thin films by sputtering on the substrate with Cr underlayer [C. Prados and G. C. Hadjipanayis, J Appl. Phys., 83, 6253, (1998); C. Prados, A. Hernando, G. C. Hadjipanayis and J. M. Gonza' leza, J. Appl. Phys., 85, 6148, (1999); C. Prados and G. C. Hadjipanayis, Appl. Phys. Letters, 74, 430, (1999).]. Proper deposition conditions, alloy composition, and heat treatments increase the coercivity up to 40 kOe which is much higher than the coercivity of conventional SmCo₅ (about 10 kOe) by other processes. In addition, using Cu as under layer in the sputtering process changes Sm—Co alloys from an in-plane to a perpendicular magnetic anisotropy [J Sayama, T. Asahi, K. Mizutani and T. Osaka, J. Phys. D: Appl. Phys., 37, L1, (2004); J. Sayama, K. Mizutani, T. Asahi, J. Ariake, K. Ouchi, S. Matsunuma and T. Osaka, J. Magn. Magn. Mater., 287, 239, (2005).], which makes it a good candidate for high density perpendicular recording media (also in terms of its excellent thermal stability and small minimal stable grain size).

A disadvantage of RE-TM permanent magnets to compete in the world market and wide use is their price [G. J. Long and F. Grandjean, Supermagnets, hard magnetic materials, Kluwer Academic Publishers, Norwell, Mass., (1991), pp 585-616.] which is strongly dependent on the manufacture process. Thin film processes, such as sputtering, PVD, and pulsed laser deposition, require a vacuum system and a high purity target to avoid impurities in deposits. In addition, the growth rates of these processes are slow. Therefore, making Sm—Co thin films by these processes is quite expensive and cannot provide any advantage in cost reduction making it difficult for commercialization. In other words, a cost effective manufacturing method must be developed to reduce the fabrication cost.

Electrodeposition is a simple, versatile and easily-controlled thin/thick film manufacturing method because of its simple setup, easy maintenance, low temperature operation, and low energy consumption. Compared to sputter, PVD, and other thin film processes, the most important advantage of electrodeposition is low cost. It was indicated that PVD process may be as much as ten times more expensive than electrodeposition [L. T. Romankiw and D. A. Thompson, “Properties of Electrodeposits,” R. Sard, H. Leidheiser, Jr., F. Ogburn, Eds., Electrochem. Soc. Chpt 23 (1975); J. W. Dini, Plat. Surf: Finish., 80, 26, (1993).]. In addition, the growth rate of electrodeposition is a lot faster than other thin film processes. This gives electrodeposition an advantage over other “thin film” technologies in thick film deposition which is often required in MEMS devices. With the help of masking patterns formed on the seedlayer, deposits of complex shape and geometry can be obtained by the electrodeposition. Therefore, electrodeposition is especially suitable to achieve high aspect ratio devices and microstructures in LIGA process [A. E. Ray and K. J. Strnat, IEEE Trans. Magnetics, Mag-8, 516, (1972).]. Electrodeposition is more versatility making it capable to adapt to various kinds of applications. Therefore, using electrodeposition should effectively reduce the fabrication cost of RE-TM thin films and make them more competitive compared to other thin film technologies. RE metal and alloys have been electrodeposited from molten salts [T. Iida T. Nohira and Y. Ito, Electrochim. Acta, 48, 901, (2003); T. Iida T. Nohira and Y. Ito, Electrochim. Acta, 48, 901, (2003).[P. Liu, Y. Du, Q. Yang, Y. Tong and G. A. Hope, J. Magn. Magn. Mater., 153, C57, (2006).] and nonaqueous solutions [Y. Sato, H. Ishida, K. Kobayakawa and Y. Abe, Chem. Lett., (8), 1471, (1990); Y. Sato, T. Takazawa, M. Takahashi, H. Ishida and K. Kobayakawa, Plat. Surf Finish., 80, 72, (1993).]. Unfortunately, most of the deposits obtained from non-aqueous media have poor magnetic properties, such as low coercivity and saturation magnetization; oxides and hydroxides can also be found in some cases after heat treatments [Y. Sato, T. Takazawa, M. Takahashi, H. Ishida and K. Kobayakawa, Plat. Surf Finish., 80, 72, (1993).]. On the other hand, only a few studies of the electrodeposition of RE-IG alloys from aqueous solutions have been reported [L. Chen, M. Schwartz, and K. Nobe, PV 96-19, p. 239, (1996); Schwartz et al., PV 98-20, p. 646, ; N. V. Myung, M. Schwartz and K. Nobe, PV 99-33, p 263, (1999) The Electrochemical Society Proceedings Series; N. V. Myung, M. Schwartz and K. Nobe, presented at the fall 2001 ECS Meeting, Abstract #680, S.F., CA (2001); M. Schwartz, N. V. Myung, and K. Nobe, J. Electrochem. Soc., 151, C468, (2004); Z. Zhang, P. Evans and G. Zangari, J. Mag. Mater., 283, 89 (2004); J. C. Wei, M. Schwartz and K. Nobe, ECS Trans., 1,(4), 273 (2006); J. Gong and E. J. Podlaha, Electrochem. Solid-State Lett., 3, 422 (2000); R. Mishra and J. Podlaha, J. Electrochem. Soc., 153,C422 (2006)].

Electrodeposition of RE metals from aqueous solutions is more difficult than from non-aqueous solutions as a result of vigorous hydrogen evolution that can be anticipated at the reduction potentials of RE metals in aqueous solution. The reduction potentials of RE metals are extremely negative (E°<−2V vs SHE) [W. M. Latimer, The Oxidation States of the Elements and Their Potentials in Aqueous Solution, Prentice-Hall, New York, pp. 286-295 (1952).], which are much lower than the reduction potential of water (H₂0+2e⁻20H⁻+1/2H₂, E=−0.826V). Therefore, instead of RE metal deposition, water tends to decompose first. In addition, RE metal ions tend to hydrolyze at PH>6 and react with dissolved oxygen or hydroxyl ions to form RE oxides and hydroxides. As a result, hydroxides and oxides would be deposited instead of RE metal making the deposition of RE metal from aqueous solution difficult, similar to electrodeposition of refractory metals such as Mo, W and V, from aqueous solutions. In 1947-1948, Schwartz initiated a commercial installation of a Co—W ammonium citrate plating process. He found that when solutions of Co and W salt were mixed, cobalt tungstate immediately precipitated but dissolved with the addition of citrate. He conjectured that both Co²⁺ and W⁶⁺ are present in the same complex with deprotonation of the hydroxycarboxylate portions, resulting in a heteronuclear biscitrate complex.

In 1994, Schwartz initiated research of the electrodeposition of RE-IG alloys from aqueous solution [M. Schwartz, Unpublished data, UCLA 1994] and tried to extend his idea of complex formation in aqueous Co—W alloy electrodeposition to RE-IG alloys. Between 1996 and 2004, a series of studies of RE-IG alloys from aqueous solutions were reported [L. Chen, M. Schwartz, and K. Nobe, PV 96-19, p. 239, (1996); Schwartz et al., PV 98-20, p. 646, (1999); Myung et al., PV 99-33, p. 263, (1999); N. V. Myung, M. Schwartz and K. Nobe, presented at the fall 2001 ECS Meeting, Abstract #680, S.F., CA (2001); M. Schwartz, N. V. Myung, and K. Nobe, J. Electrochem. Soc., 151, C468, (2004)]. The experimental results indicated that RE and IG metals can be co-deposited by addition of appropriate complexants, such as glycine, its derivatives and other amino carboxylates, into the aqueous solution. In contrast to those prior studies, disclosed herein are improved co-depositions procedures for forming Sm—Co alloys from non-Cl⁻ aqueous solutions for use in the fabrication of high performance SmCo₅ and Sm₂Co₁₇ permanent magnets, These improved procedures and alloys, which were not previously disclosed, provide much lower costs and more flexibility in fabrication than existing manufacturing processes.

1. electrodeposition of RE-CO (Rare Earth-Co) Alloys from Aqueous Solutions

There have been only a few reports of codeposition studies of Sm—Co alloys from aqueous solution, mostly by the UCLA group [L. Chen, M. Schwartz, and K. Nobe, PV 96-19, p. 239, (1996); M. Schwartz, F. He, N. Myung, and K. Nobe, PV 98-20, p. 646, (1999); N. V. Myung, M. Schwartz, and K. Nobe, PV 99-33, p. 263 (1999); N. V. Myung, M. Schwartz and K. Nobe, presented at the fall 2001 ECS Meeting, Abstract #680, S.F., CA (2001); M. Schwartz, N. V. Myung, and K. Nobe, J. Electrochem. Soc., 151, C468, (2004).]. Zangari synthesized Sm—Co nanoparticles [J. Zhang, P. Evans, and G. Zangari, J. Magn. Magn. Mater., 283, 89, (2004).] directed to single short pulse electrodeposition using the solution developed by Schwartz et al. (see above references).

In 1996, Chen et al. [L. Chen, M. Schwartz, and K. Nobe, PV 96-19, p. 239 (1996).] published the first study of RE-IG alloys from aqueous solution. Electrodepositions was carried out at room temperature and pH 4 from the plating solution containing RE mixtures, Co, Fe or Ni chloride salts, and various addition agents; soluble anodes were used. In direct current (DC) electrodeposition, it was noted that RE was not found in the deposits from the solutions at pH<4. RE deposit content (RE-Co and RE-Ni) increased with increasing current density (CD) from 5 to 20 mA/cm². RE deposit content was higher for RE -Fe than for RE-Ni and RE-Co. In pulsed current (PC) electrodeposition, higher temperatures and cobalt concentrations resulted in lower RE deposit content. For codeposition of these metallic RE-IG alloys, specific addition agents (i.e. aminocarboxylates) were required in the plating solution.

In 1998, Schwartz et al. [M. Schwartz, F. He, N. Myung, and K. Nobe, PV 98-20, p. 646, (1999).] reported the use of plating solutions containing 0.3M RE metal ions (i.e. La, Ce, Nd, Gd and RE mixtures), 0.12M IG ions, 0.36M complexant (e.g., glycine, alanine and serine), 1M NH₄Cl and 0.5M H₃BO₃ to obtain IG-RE alloys at room temperature. In DC electrodeposition, it was found that the addition of NH₄Cl improved solution stability and deposit appearance. RE deposit content decreased in the order: glycine>serine>alanine. With glycine, the RE deposit content increased: Co<Fe<Ni. PC electrodeposition extended the effective peak CD range for metallic deposits. However crack density was directly related to the deposit RE content.

In 1999, Myung et al. [N. V. Myung, M. Schwartz, and K. Nobe, PV 99-33, p. 263, (1999).] used chloride-based plating solutions containing 0.3M RE ions (i.e. Nd or Sm), 0.12M IG ions (i.e. Co and Ni), 0.36-0.72M glycine and 1M NH₄Cl to obtain RE-IG alloys at room temperature. 0-0.4M DMAB (dimethylamineborane) was added to solutions to obtain ternary RE-IG-B alloys. Soluble IG served as anodes, and brass and stainless steel panels served as cathode substrates. Metallic Nd—Ni—B alloys were electrodeposited at pH6 and CD<40 mA/cm². Increased CD led to increased Nd content, decreased B content and current efficiency. Increasing glycine/Ni ion concentration decreased Nd content and increased current efficiency. Metallic Sm—Co and Sm—Co—B alloys were obtained at pH 4-6.5, CD<40 mA/cm². In the absence of DMAB in solutions, Sm content increased with increased CD; in the presence of DMAB, the opposite trend was observed. However, Sm content in the end product was limited to less than about 4% w. The crystal structures of Sm—Co and Sm—Co—B alloys were hexagonal closed pack (hcp) (CD<10 mA/cm²) or non-crystalline (CD>10 mA/cm²) Deposit grain size reduced from 128 to 38 nm by increased CD from 5 to 30 mA/cm².

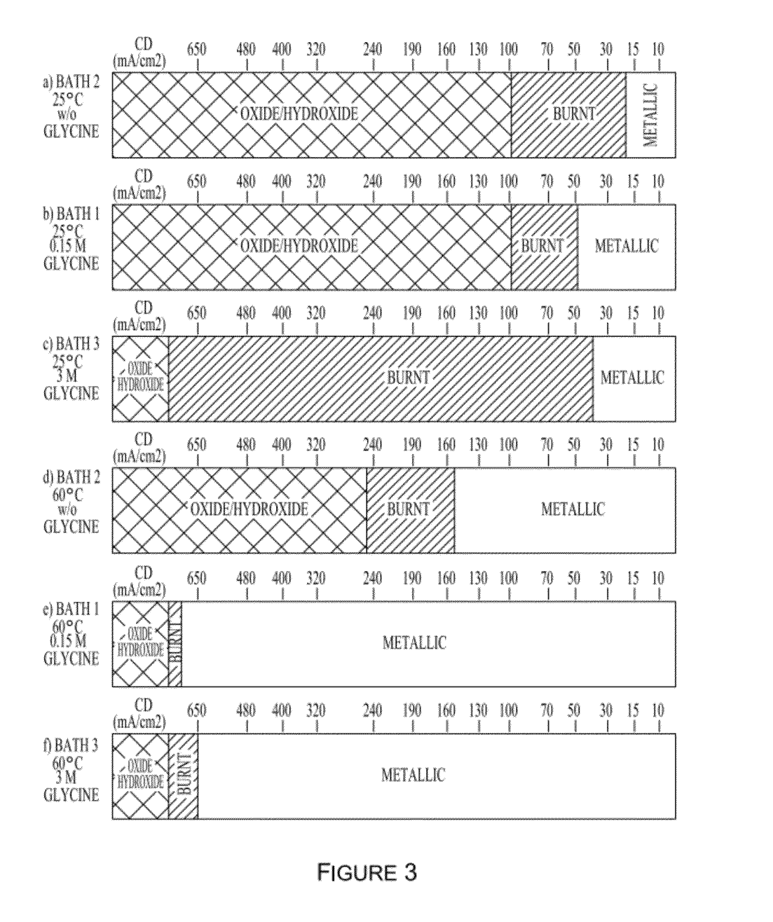

In 2001 Myung et al. [N. V. Myung, M. Schwartz and K. Nobe, Fall 2001 ECS Meeting, Abstract #680, S.F., CA (2001)] presented some preliminary experimental data of aqueous electrodeposition of SmCo alloys from all-sulfamate baths. These results were later included in a 2004 paper (FIGS. 3, 5, 9 [M. Schwartz, N. V. Myung, and K. Nobe, J. Electrochem. Soc., 151, C468, (2004).] Applicants previous studies used Cr based baths [L. Chen, M. Schwartz, and K. Nobe, PV 96-19, p. 239, (1996); M. Schwartz, F. He, N. Myung, and K. Nobe, PV 98-20, p. 646, (1999); N. V. Myung, M. Schwartz, and K. Nobe, PV 99-33, p. 263 (1999)]. In all studies between 1996-2004, amino acids were found to be effective complexing agents for the codepositionj of vRE alloys; glycine resulted in higher RE deposit contents than serine and alanine (glycine>serine>alanine) at room temperature. Electrodeposits from a Cl⁻ bath are usually highly stressed while those from a sulfamate bath are usually less stressed. Residual stress could have an adverse effect on mechanical and physical (including magnetic) properties of deposits [J. W. Dini, Electrodeposition: The Materials Science of Coatings and Substrates, Chpt. 9, Noyes Publications, Park Ridge, N.J., 1993; R. Weil, Plating, p. 50, January 1971]. The magnetic properties of SmCo deposits from non-Cr baths are equivalent to those obtained from prior physical deposition methods, such as sputtering.

In 2004, Zhang et al. [J. Zhang, P. Evans, and G. Zangari, J. Magn. Magn. Mater., 283, 89, (2004).]' used the plating solution (recited as reference 12) developed by Myung et al. [N. V. Myung, M. Schwartz, and K. Nobe, PV 99-33, p. 263, (1999); N. V. Myung, M. Schwartz and K. Nobe, Fall 2001 ECS Meeting, Abstract #680, S.F., CA (2001)] to synthesize Sm—Co nanoparticles by single short pulse electrodeposition. Nanoparticle composition was a function of pulse amplitude (PCD 0.1-1.5 A/cm²) and pulse duration (Tₒₙ=5-100 ms); the relative atomic percent of Sm, defined as Sm/(Sm+Co), increased with increasing PCD and decreasing Tₒₙ. XRD and XPS data indicate that hcp Sm—Co metallic alloys mixed with metal oxides have been obtained. The oxygen atomic ratio O/(Sm+Co+O) was a function of Tₒₙ. Increasing Tₒₙ decreased Sm content, while oxygen content increased up to a maximum of about 50at %. For short Tₒₙ (few ms), oxygen content was as low as 3at % (PCD=1000 mA/cm²). While Zhang reported films with (Sm/Sm—Co) of 90% Sm or more, these were very thin, non-metallic, oxide/hydroxide films. In-plane coercivities of Zhang et al films up to 5.3 kOe were reported for as-plated metallic nano-size particles of about 80 nm with Sm content of about 20 at %.

2. Description of the Electrodeposition Process

In one aspect, the invention relates to methods for electrodepositing a samarium-cobalt coating onto a conducting (e.g., metal) substrate, comprising placing an aqueous solution containing a water soluble salt of samarium, a water soluble salt of cobalt, optionally one or more supporting electrolytes, and a complexant into a plating bath, placing an anode and the substrate to be coated into the bath and connecting the anode and the substrate to a power supply, with the substrate acting as the cathode, adjusting the pH of the bath to a suitable operating level, and applying a direct current through the anode and substrate causing the samarium and the cobalt to migrate to, and adhere to, the substrate.

In one aspect, the complexant can be one or more amino acids. The amino acid can be any amino acid known to those of skill in the art. In a further aspect, the amino acid is selected from amino carboxylates, for example, glycine, alanine, and serine.

In a further aspect, the complexant can be one or more hydroxycarboxylic acid. In a further aspect, the hydroxycarboxylic acid is selected from glycolic and lactic acids.

In one aspect, the one or more supporting electrolytes (e.g., conducting salts) can be any electrolytes known to those of skill in the art. In a further aspect ammonium sulfamate can be used as the electrolyte.

In one aspect, the aqueous solution comprises from about 0.25M to about 2.0M of the water soluble salt of samarium, from about 0.01M to about 0.5M of the water soluble salt of cobalt, from about 0.05M to about 0.5M of the complexant, and can include up to about 3M of the supporting electrolyte. In a further aspect, the aqueous solution comprises about 1M of the water soluble salt of samarium, about 0.05M of the water soluble salt of cobalt, about 0.15M of the complexant, and optionally about 1M of the supporting electrolyte.

In one aspect, the water soluble salt of samarium is samarium sulfamate. In one aspect, the water soluble salt of cobalt is cobalt sulfate or cobalt sulfamate. In one aspect, the complexant is an amino acid, for example, glycine. In one aspect, the complexant is a hydroxycarboxylic acid, for example lactic acid. In one aspect, the supporting electrolyte is ammonium sulfamate. In a further aspect, the water soluble salt of samarium is samarium sulfamate, the water soluble salt of cobalt is cobalt sulfate or cobalt sulfamate, the complexant is glycine, and optionally the supporting electrolyte is ammonium sulfamate.

In various aspects, a current density of from about 5 mA/cm² to about 600 mA/cm² is applied across the anode and cathode. In a further aspect, the current is a DC current. In a further aspect, the current is an alternating current. In a further aspect, the current is applied with pulse current modifications with varying duty cycle and frequency.

In one aspect, the pH of the solution is from about 4 to about 6. In a further aspect, the pH of the solution is about 6.

In one aspect, the electrodeposition is conducted at a temperature from about 20° C. up about 80° C. In a further aspect, the electrodeposition is conducted at a temperature of from about 25° C. to about 60° C. In a further aspect, the solution temperature is from about 25° C. to about 40° C. In a yet further aspect, the electrodeposition is conducted at about room temperature.

The electrodeposition can be conducted with stirring or other means of solution agitation. In a further aspect, the electrodeposition is conducted without stirring. In a further aspect, the electrodeposition is conducted with oscillatory stirring.

It is understood that the disclosed compositions can be used in connection with the disclosed methods.

Also disclosed are samarium-cobalt coatings produced by the disclosed methods, these SmCo coatings having Sm contents greater than from about 20 at % to less than about 35% and in a preferred embodiment less than about 32.5 at %.

a. Hull Cell Studies

Sm—Co permanent magnets, such as Sm₂Co₁₇ and SmCo₅, require 10.53 and 16.67 at % Sm content, respectively. To satisfy the composition requirements of Sm—Co magnets, the alloys produced by electrodeposition must contain enough Sm content. Therefore, high Sm content Sm—Co alloys electrodeposited from aqueous solution was the initial objective.

An electrodeposition process can be operated successfully only when the key parameters are properly controlled. These parameters comprise the components and compositions of plating baths (e.g. metal ions, supporting electrolytes and additives) and operating conditions (e.g. current density (CD), solution temperature, pH, fluid dynamics and current waveforms). To obtain high Sm deposit content, these parameters must be properly selected.

The Hull cell, developed by R. O. Hull [R. O. Hull, U.S. Pat. No, 2,149,344 (1939), is an effective screening device often used by electroplaters to solve problems in the electroplating process. The Hull cell has been recognized as a powerful tool to study the approximate deposit properties. Generally, the Hull cell provides information regarding the deposit characteristics over a wide range of CDs and multiple experimental results in a single experiment. Further, deposits on selected portions of the test panel can be analyzed by energy dispersive spectroscopy (EDS) and X-ray diffraction (XRD) to provide additional information regarding compositions and crystal structures. The current density at which the deposit no longer has a metallic appearance, referred to as “burnt” by practicing electroplaters, was defined as the maximum current density (CDₘₐₓ) for a particular plating system. Because of its high efficiency, Hull cell technology was chosen to determine the dependence of Sm deposit content on deposit parameters and the interaction between deposit parameters in the electrodeposition of Sm—Co alloys. While the result obtained using the Hull cell is less accurate and more limited than the use of parallel electrodes, it still provides a good approximation of the trends in Sm deposit content obtained by varying the electrodeposition parameters in the initial studies of the electrodeposition of Sm—Co alloys.

(1) Results—Hull Cell Electrodeposition

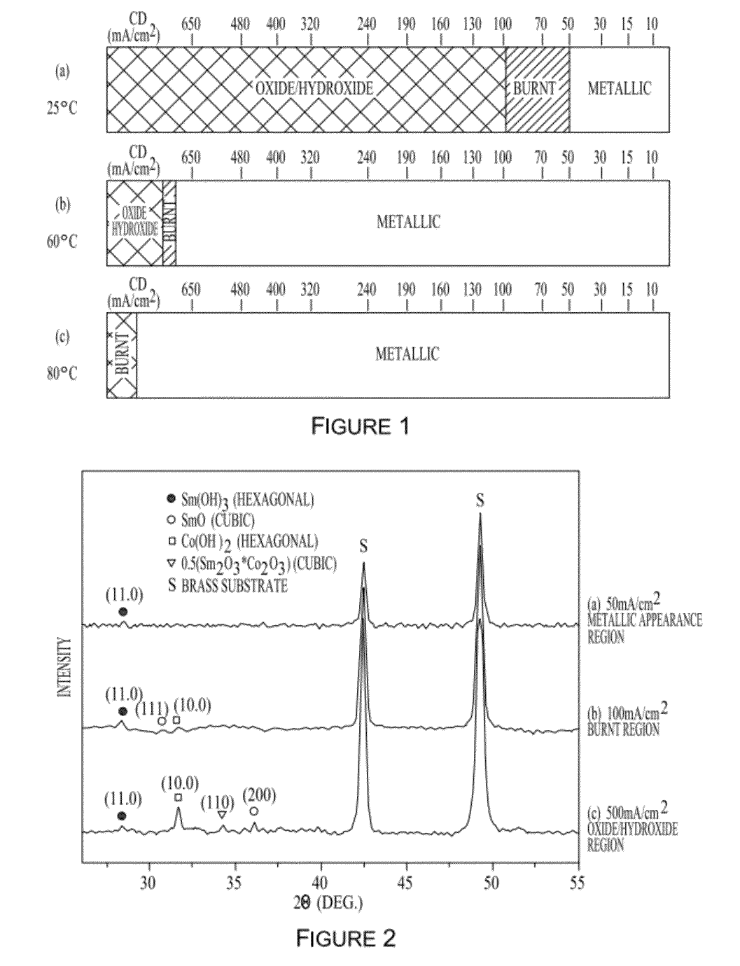

Effects of current density and solution temperature on Hull cell patterns of electrodeposited Sm—Co alloys are shown in Table 2, and FIG. 1.

TABLE 2
The effects of current density and solution temperature

| | [Sm(NH₂SO₃)₃] | [CoSO₄] | [Glycine] | | T | CDₘₐₓ |
|---|---|---|---|---|---|---|
| Bath | (M) | (M) | (M) | pH | (° C.) | (mA/cm²) |
| 1 | 1.00 | 0.05 | 0.15 | 5.7 | 25 | 50 |
| | | | | | 60 | 750 |
| | | | | | 80 | 850 |

*Total charge = 100 C., applied current = 4.5 A, substrate area-15 cm², pH = 5.7, no agitation

Deposits obtained from bath 1 at 25° C., for example, had a metallic-appearance below 50 mA/cm², burnt between 50 and 100 mA/cm², and comprised a white oxide/hydroxide powder at CD above 100 mA/cm² (FIG. 1(a)). Increasing the bath temperature, for example to 60 or 80° C. (FIG. 1(b) and (c)) resulted in more metallic deposit and reduced burnt or oxide deposits. To characterize these regions, XRD was used to study their phase compositions. From the result of XRD patterns of deposit (FIGS. 2a-c), the metallic region was non-crystalline and contained a very small weak diffraction peak of Sm(OH)₃ (FIG. 2(a)). The burnt region exhibited not only Sm(OH)₃ but also Co(OH)₂ and SmO peaks (FIG. 2(b)). The non-metallic white powder region (FIG. 2(c)) contained Sm(OH)₃, Co(OH)₂ and mixtures of Sm and Co oxides.

Generally, metallic deposits could be obtained only below the critical CD; at higher CDs, non-metallic appearing deposits containing hydroxides and oxides were obtained. This critical CD was defined as the maximum current density (CDₘₐₓ) to obtain metallic deposits. It was observed that CDₘₐₓ increased with increasing solution temperature (Table 2 and FIG. 1). For example, CDₘₐₓ increased from 50 to 850 mA/cm² by increased solution temperature from 25 to 80° C. Higher CD resulted in higher Sm deposit content. Therefore, high Sm deposit content of 25 at % can be obtained from bath 1 at 60° C. and 650 mA/cm² exceeding the composition requirement of 16.67 at % for SmCo₅.

(2) Electrodeposition of Sm—Co Alloys

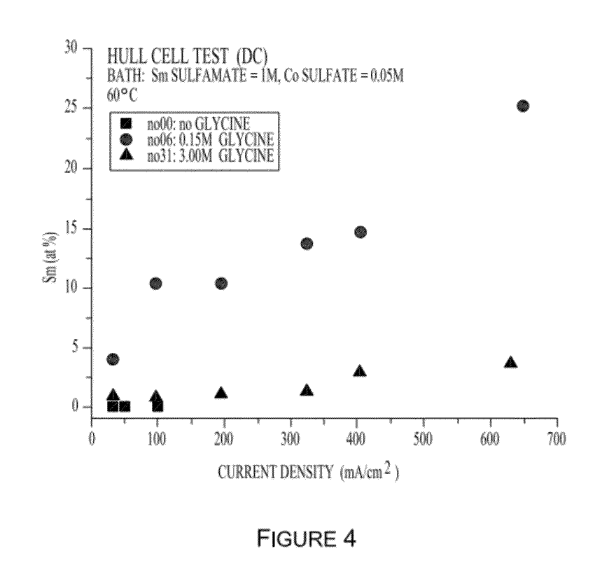

Glycine can form complexes individually with both Sm and Co ions. Sm³⁺ complexed with glycine can not be electrodeposited to Sm. Previous work [M. Schwartz, F. He, N. Myung, and K. Nobe, PV 98-20, p. 646, (1999)] has shown that Sm—Co alloys can be electrodeposited from aqueous solutions containing Sm³⁺, Co and glycine (or other appropriate complexers). Electrodeposition of Sm—Co alloys have now been studied at 25 and 60° C. in the absence and the presence of glycine at two concentrations; Bath 1, bath 2 and bath 3 were selected, as shown in Table 3. The Hull cell patterns and Sm content of deposits from these three baths are shown in FIG. 3 (for 25 and 60° C.) and FIG. 4 (for 60° C. only), respectively. In the absence of glycine, deposits contained considerable hydroxides/oxides.

TABLE 3
The effect of glycine on electrodeposition of
Sm—Co alloys at 25 and 60° C.

| | | | | [Gly- | | | CDₘₐₓ |
|---|---|---|---|---|---|---|---|
| EXP | | [Sm(NH₂SO₃)₃] | [CoSO₄] | cine] | | T | (mA/ |
| # | Bath | (M) | (M) | (M) | pH | (° C.) | cm²) |
| 15 | 2 | 1.00 | 0.05 | 0 | 5.8 | 25 | 20 |
| 3 | 1 | | | 0.15 | 5.7 | | 50 |
| 25 | 3 | | | 3.00 | 4.0 | | 40 |
| 22 | 2 | 1.00 | 0.05 | 0 | 5.8 | 60 | 150 |
| 6 | 1 | | | 0.15 | 5.7 | | 750 |
| 31 | 3 | | | 3.00 | 4.0 | | 650 |

* Total charge = 100 C., applied current = 4.5 A, substrate area = 15 cm², no agitation.

The addition of glycine extended the metallic deposit region by increasing CDₘₐₓ. CDₘₐₓ from 0 to 3M (FIG. 3) increased, reached a maximum, and then decreased with increased glycine concentration. At 60° C., for example, the CDₘₐₓ increased from 150 mA/cm² (no glycine), reached a maximum of 750 mA/cm² (0.15M glycine), then slightly decreased to 650 mA/cm² (3M glycine).

However, with the addition of excess glycine (3M glycine, 60° C. bath 3), CDₘₐₓ decreased (FIG. 3(f)) and Sm deposit content decreased (FIG. 4). At 60 ° C. and 400 mA/cm², for example, the Sm content drops substantially from 14.7 to 2.9 at % as the concentration of glycine increased from 0.15 to 3M. Excess glycine may complex virtually all of the Co²⁺ and additional Sm³⁺ resulting in the formation of mononuclear complexes, Co(gly)⁻₃ and Sm(gly)₃, at the expense of forming the heterodinuclear complexes required for the codeposition of Sm—Co alloys as previously proposed.[N. V. Myung, M. Schwartz, and K. Nobe, PV 99-33, p. 263, (1999).]

2. Direct Current (DC) Electrodeposition Studies

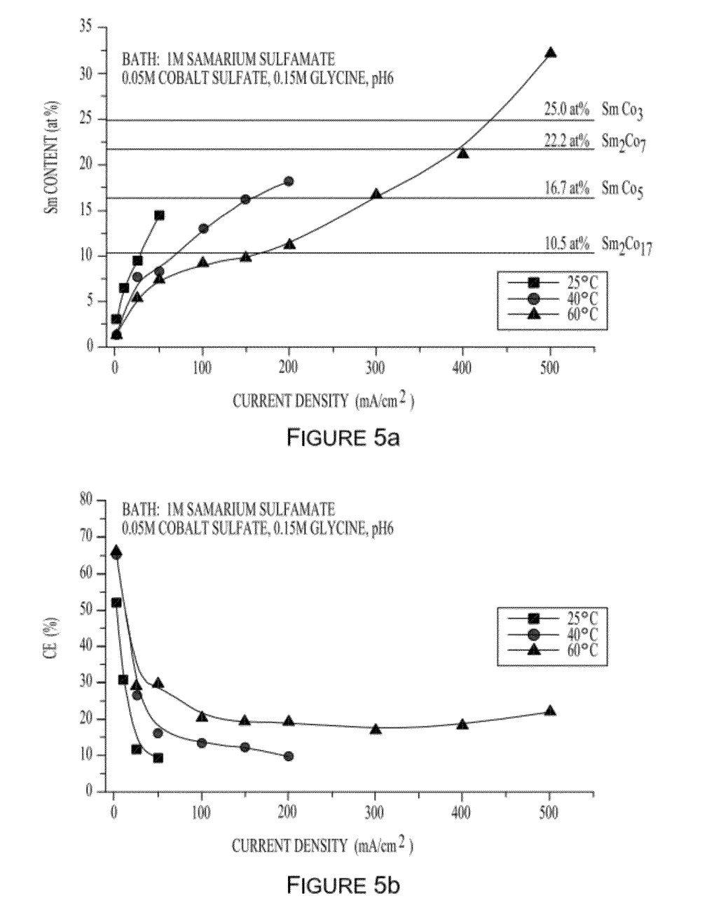

DC electrodeposition using a parallel electrode system was investigated to determine, more precisely, the optimum operating and aqueous bath conditions, estimated by the Hull cell studies, to obtain high Sm content, metallic Sm—Co alloys. The purpose was to obtain sufficient compositions of Sm—Co alloys to form intermetallic Sm₂CO₁₇ (10.5 at % Sm) and SmCo₅ (16.7 at % Sm), and, in addition, Sm₂O₇ (22.2 at % Sm) and SmCo₃ (25 at % Sm) after appropriate heat treatment procedures (FIG. 5).

Samarium content in deposited films increased with increasing current density. Increasing solution temperatures from 25 to 60° C. effectively extended the CD to obtain metallic deposits. (CD)ₘₐₓ increased from 50 to 500 A/cm² leading to a high Sm deposit content of at least about 32 at % using a bath consisting of 1M Sm sulfamate, 0.05M Co sulfate, 0.15M glycine at 60° C.

Crystal structures were dependent on Sm content. Deposits changed from crystalline to non-crystalline structures as the Sm deposit content increased. Crystal structures of electrodeposited Sm—Co crystallites were dominated by hcp phases. While higher Sm content deposits were usually accompanied by more microcracks due to higher internal stress by lattice distortion, lower microcrack densities were found in the deposit obtained at higher solution temperatures.

Magnetic properties of electrodeposited SmCo alloys were also found to be strongly dependent on alloy composition, crystal structure and particle size. Increased Sm content resulted in deposits changing from crystalline to non-crystalline structures and decreased grain size. Magnetic saturation (Ms) decreased linearly with increased Sm deposit content and was in agreement with sputtered films. On the other hand, deposits with high oxide/hydroxide content had much lower Ms values. For deposits obtained at different conditions, perpendicular coercivity was much higher than parallel coercivity which fluctuated between 50 and 150 Oe.

In DC electrodeposition studies, deposits on parallel electrodes confirm the Hull cell results (FIG. 5).

(1) Pretreatment and Post-Treatment

Before electrodeposition, the brass panels were mechanically cleaned, soaked in 0.1M NaOH solution for 10 min., rinsed in deionized water, immersed in 10% HCl for 30 seconds and then rinsed with deionized water. Unless otherwise noted, the total charge passed was 50 coulombs; solutions were not agitated during electrodeposition.

After the deposition of Sm—Co alloys at 50 coulombs, the plates with deposits were removed from plating solution, rinsed with deionized water, and dried with nitrogen gas. Disk-shaped specimens of diameter of 6.4 mm (specimen area=31.7 mm²) were fabricated from deposits for analysis.

(2) characterization and Analysis

The samarium

$$\frac{Sm}{Sm + Co} ( at \% )$$

and cobalt deposit content

$$\frac{Co}{Sm + Co} ( at \% )$$

were determined by an energy dispersive x-ray spectroscopy (EDS) with a Kevex detector in a Cambridge SEM the mass of deposited cobalt was measured by a PerkinElmer flame atomic absorption spectrometer (AA, model 631); the crystal structure, orientation, phase identification and grain size were determined by a PANalytical x-ray diffraction system (XRD, model X′Pert Pro); the surface morphology, microstructure and grain size were observed by a JEOL scanning electron microscopy (SEM, model JSM-6700F); magnetic properties were determined by a ADE Tech. vibrating sample magnetometer (VSM, model 1660). Unless otherwise noted, the data presented are restricted to deposits with a metallic appearance.

(3) Effect of CD and Solution Temperature

Alloy Composition: Samarium deposit content shown as atomic per cent (at %) increased with increasing current density (CD). CDₘₐₓ (the highest CD to obtain metallic deposits) was extended by use of elevated solution temperatures (FIG. 5(a)). At 25 ° C., CDₘₐₓ was limited to 50 mA/cm² (Sm=14.5 at %), whereas for a solution temperature of 60° C., CDₘₐₓ≧500 mA/CM², resulting in deposit Sm content of 32.1 at %. Depending on CD and solution temperature, deposits of Sm content between 0 and 32 at % could be obtained from bath 1 which satisfies the stoichiometric compositions of intermetallic Sm₂Co₁₇ (10.5 at %) and SmCo₅ (16.7 at %) as well as Sm₂Co₇ (22.2 at %) and SmCo₃ (25 at %). Therefore, Sm—Co alloys of sufficient Sm content for Sm—Co magnets (i.e. Sm₂Co₁₇ and SmCo₅) were shown to be produced by electrodeposition.

At 60° C., increasing CD (from 2 to 500 mA/cm²) resulted in a substantial increase in Sm deposit content from 1.3 to 32.1 at % (FIG. 5(a)). At 25° C., Sm deposit content increased from 3 to 15 at % with increasing CD from 2 to 50 mA/cm² with a sharp decrease in Co.

(4) Crystal Structures

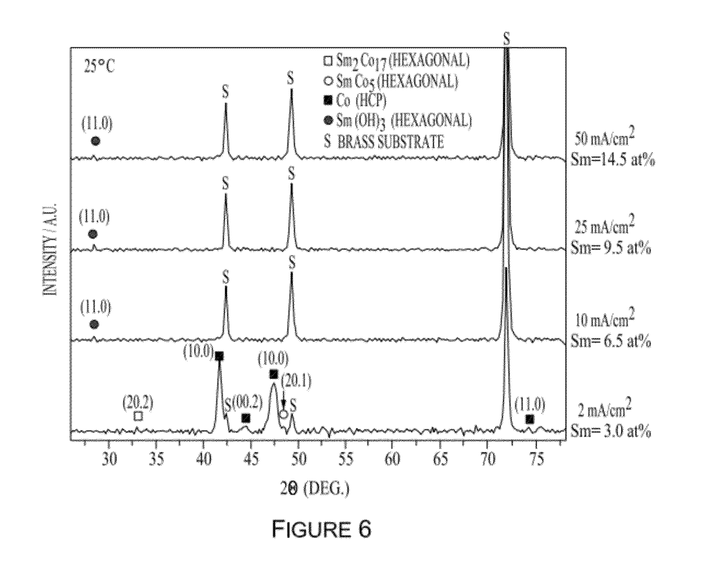

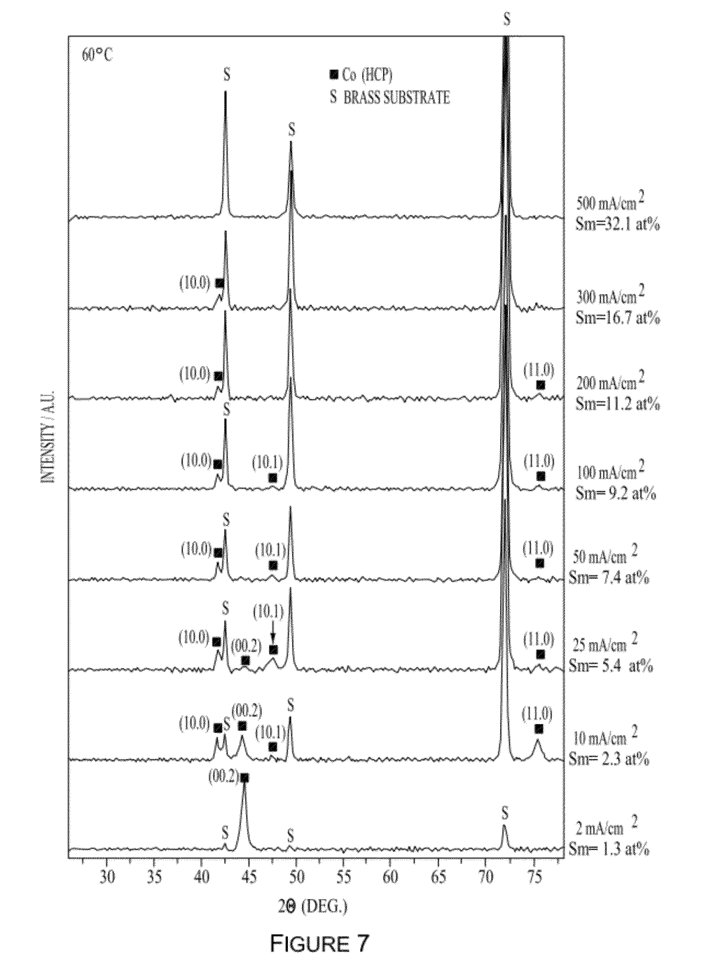

The dependence of crystal structures on CD and solution temperature was determined by XRD. FIG. 6 and FIG. 7 show XRD results for deposits obtained from bath 1 at various CDs and at 25 and 60° C., respectively. It is noted that increased CD resulted in deposits changing from crystalline (or semi-crystalline) to non-crystalline; no diffraction peaks for Co, Sm or Sm—Co intermetallics were found between 10 and 50 mA/cm² at 25° C. and Sm or Sm—Co intermetallics between 2 and 500 mA/cm² at 60° C.; Co peaks disappeared at 60° C. and 500 mA/cm². Crystal structures of electrodeposited Sm—Co crystallites were dominated by α-Co (hcp) phases; neither β-Co (fcc) nor Sm (rhombohedral) phases were found in deposits.

At 25° C. (FIG. 6), (10.0), (00.2), (10.1) and (11.0) peaks of α-Co and very weak (20.1) peak of SmCo₅ (hexagonal) and (20.2) peak of Sm₂Co₁₇ (hexagonal) were observed at 2 mA/cm² (Sm =3 at %). In addition, weak (11.0) peaks of Sm(OH)₃ were found in the deposits at 25° C., but not at 60° C. (see FIG. 7).

At 60 ° C. (FIG. 7), a strong (00.2) peak of α-Co was observed at 2 mA/cm²; this peak decreased with increased CD (10 and 25 mA/cm²). Mixed orientations of (10.1), (11.0) and (10.0) peaks appeared from 10 (Sm 2.3 at %) to 100 mA/cm² (Sm =9.2 at %). The (00.2) peak disappeared at 50 mA/cm². Crystalline peaks were not seen at 500 mA/cm² (Sm=32.1 at %).

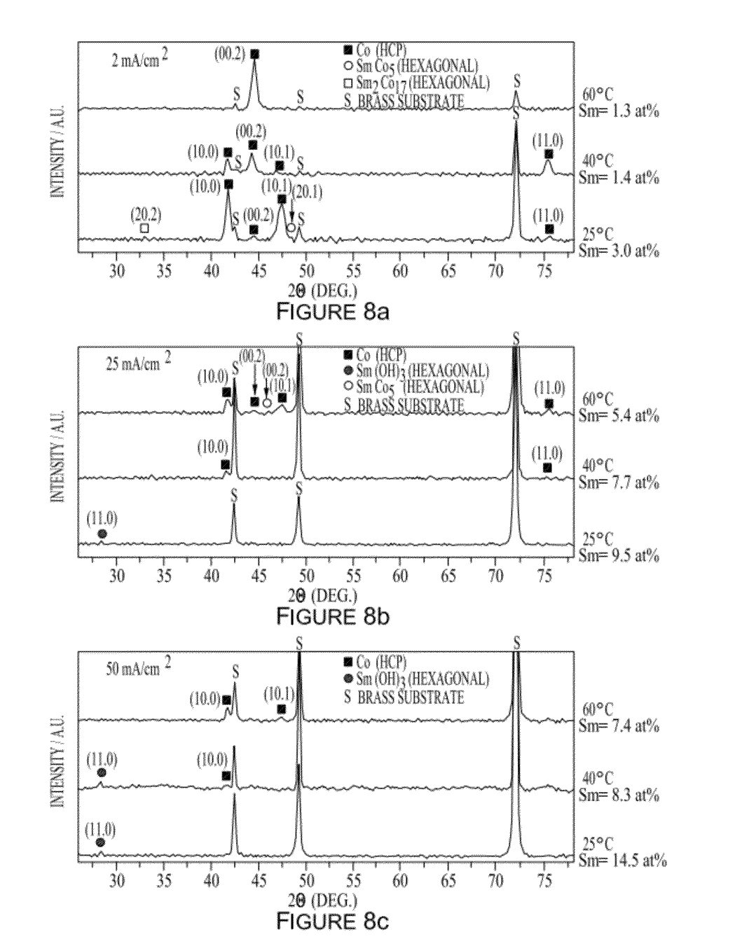

The effect of solution temperature on deposit crystal structures at various CDs (2, 25 and 50 mA/cm²) are compared in FIG. 8. At higher CDs (25 and 50 mA/cm²), lower solution temperatures resulted in deposits changing from crystalline to non-crystalline structures, similar to the effect of the increase of CD on deposit crystal structures (see FIG. 7 and FIG. 8). At low CD (2 mA/cm²), the decrease of solution temperature from 60° C. (Sm =1.3 at %) to 25° C. (Sm=3 at %) resulted in the decrease of α-Co (00.2) peak intensity, and other α-Co orientations (i.e. (11.0), (10.0) and (10.1)) were observed at 25 and 40° C. These orientations were also seen at 60° C., and both 10 and 25 mA/cm² (FIG. 7).

According to these XRD results, the change in deposit orientation follow the same trend as varying CD or solution temperature and are related to Sm deposit content (or cathode potential). Higher solution temperatures required higher Sm content to produce non-crystalline deposits.

The dependence of orientation of electrodeposited Sm—Co alloys is similar to electrodeposited hcp Co and is strongly related to CD, solution temperature and Sm content.

(5) Morphologies and Microstructures

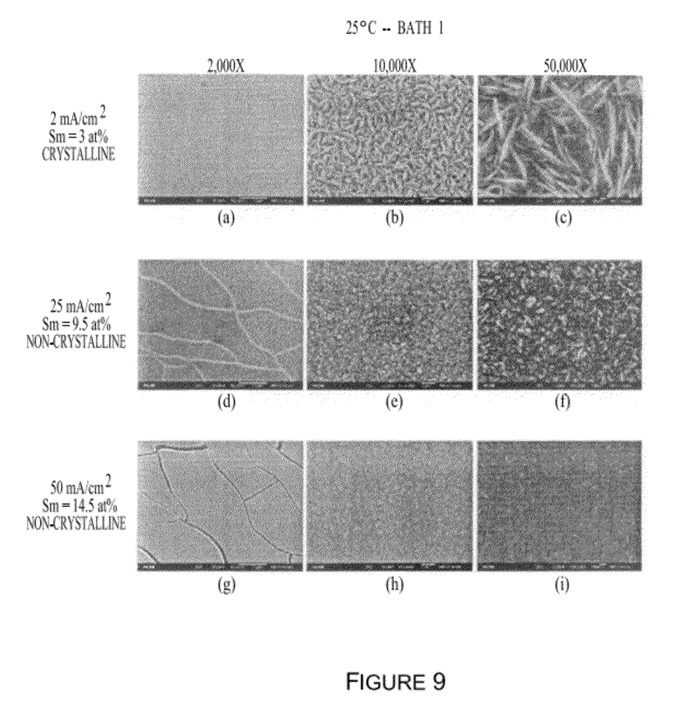

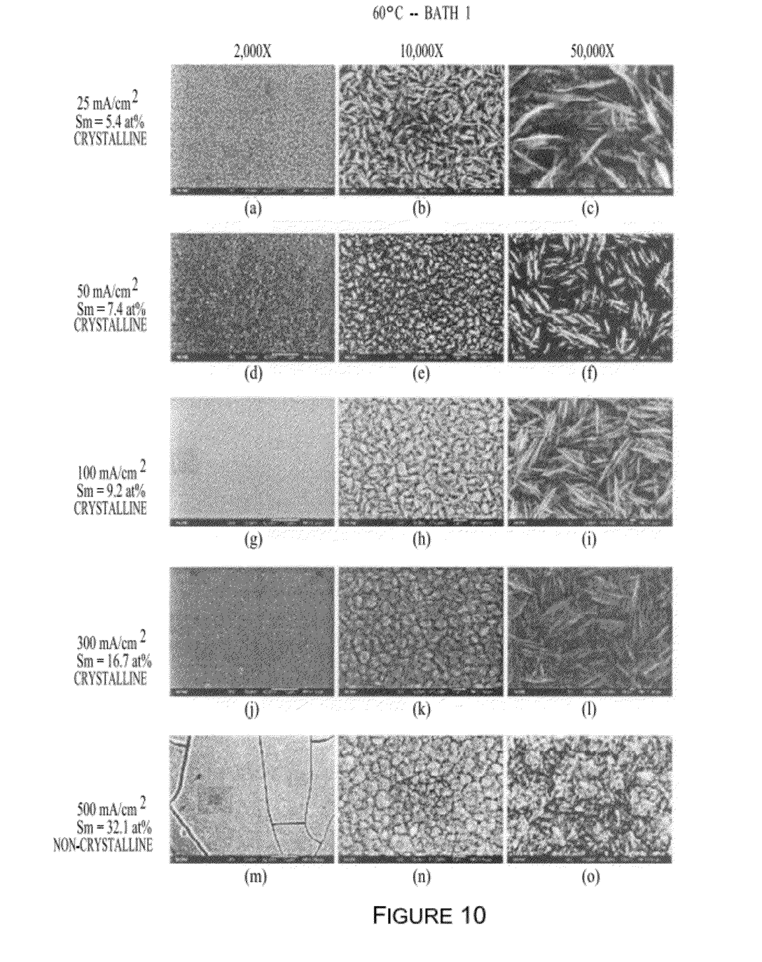

SEM pictures (FIG. 9 and FIG. 10) show the dependence of morphology and microstructure on CD at 25 and 60° C., respectively. The increase in Sm content due to increased CD (FIG. 9 and FIG. 10) or decreased solution temperature resulted in more microcracks and smaller particle sizes.

Microstructures of crystalline deposits were fiber-shaped nano-rods. With increased Sm content, deposits changed to non-crystalline structures (see XRD results) consisting of tiny roundish particles.

(6) Magnetic Properties

The most important characteristics governing the quality of electrodeposited hard magnetic films (i.e. coercivity Hc, saturation magnetization Ms and squareness Mr/Ms) are grain size, crystal structure, orientation and the presence of alloying elements [L. T. Romankiw and D. A. Thompson, in Magnetic properties of plated films in Properties of Electrodeposits: Their Measurements and Significance, Electrochemical Society, Princeton, N.J. (1975), pp 389-426]. Magnetic hysteresis loops of deposits obtained at various CDs and solution temperatures were measured by VSM for an applied magnetic field scanning between −10 and 10 K Oe. In-plane (∥) and perpendicular (⊥) measurements represent the magnetic field applied parallel and perpendicular to the film plane, respectively. Magnetic properties of Hc, Ms and squareness were obtained from hysteresis loops.

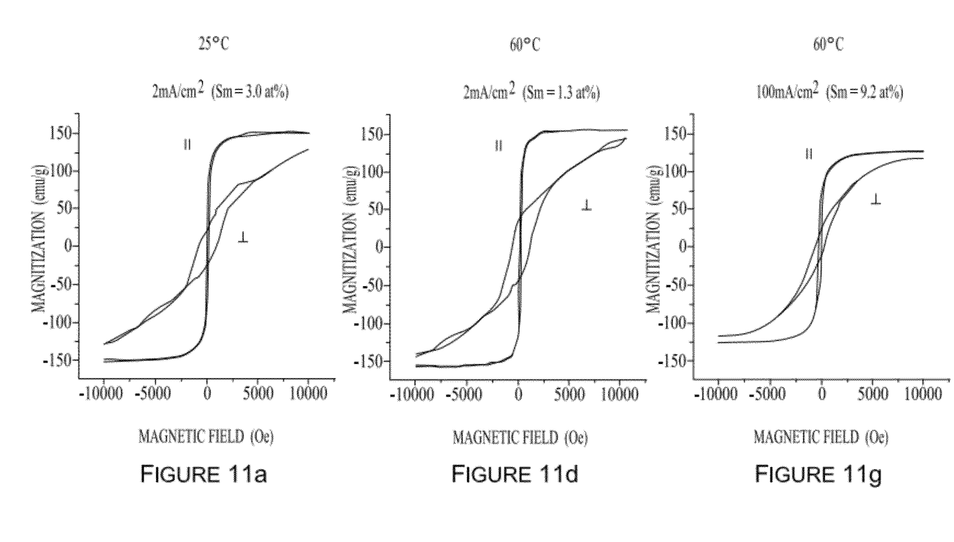

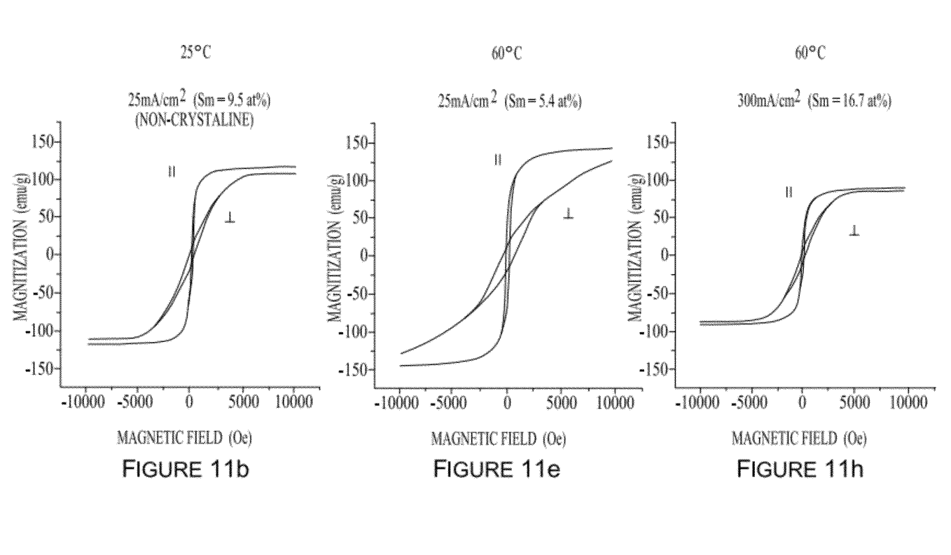

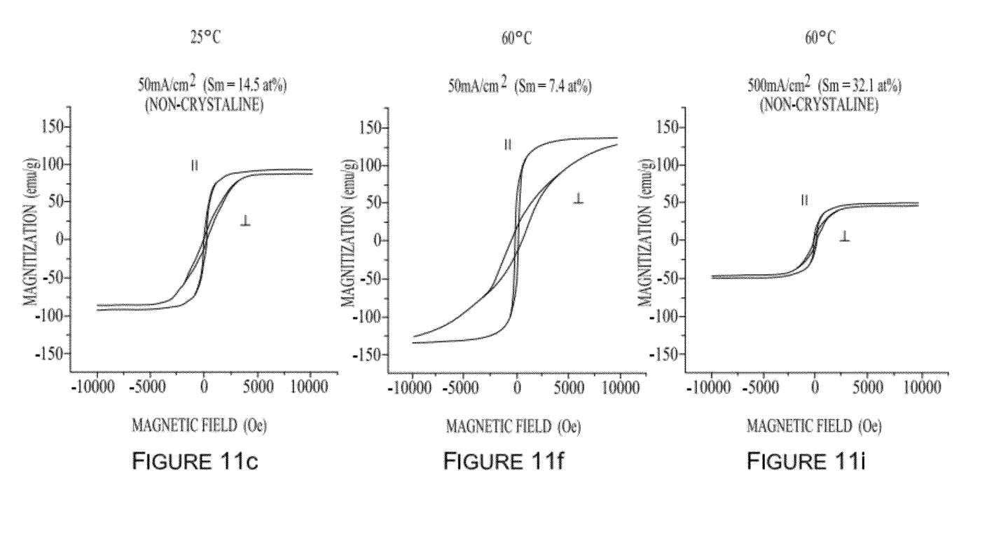

FIG. 11 gives examples of hysteresis loops obtained at 25 and 60° C. and at various CDs. It was noted that magnetizations (Ms) were easier in the in-plane direction than the perpendicular direction indicating the easy-axis (EA) along the in-plane direction and the hard axis (HA) along the perpendicular direction. At 25 and 60° C., Ms_{∥} were higher than Ms⊥, and they approached each other sooner as the magnetic field increased. Ms_{∥} is used for the following discussion regarding approaching magnetization saturation. On the other hand, Hc⊥ were higher than Hc_{∥}, and they got closer to each other as CD increased. At 25 and 60° C., Ms and Hc⊥ decreased as CD increased. At constant CD, Ms and Hc increased as solution temperature increased from 25 to 60° C. These results can be correlated to the alloy compositions and crystal structures of deposits. When deposits changed from crystalline to non-crystalline structures with increased Sm content obtained by increased CD, magnetic properties of deposits were more isotropic.

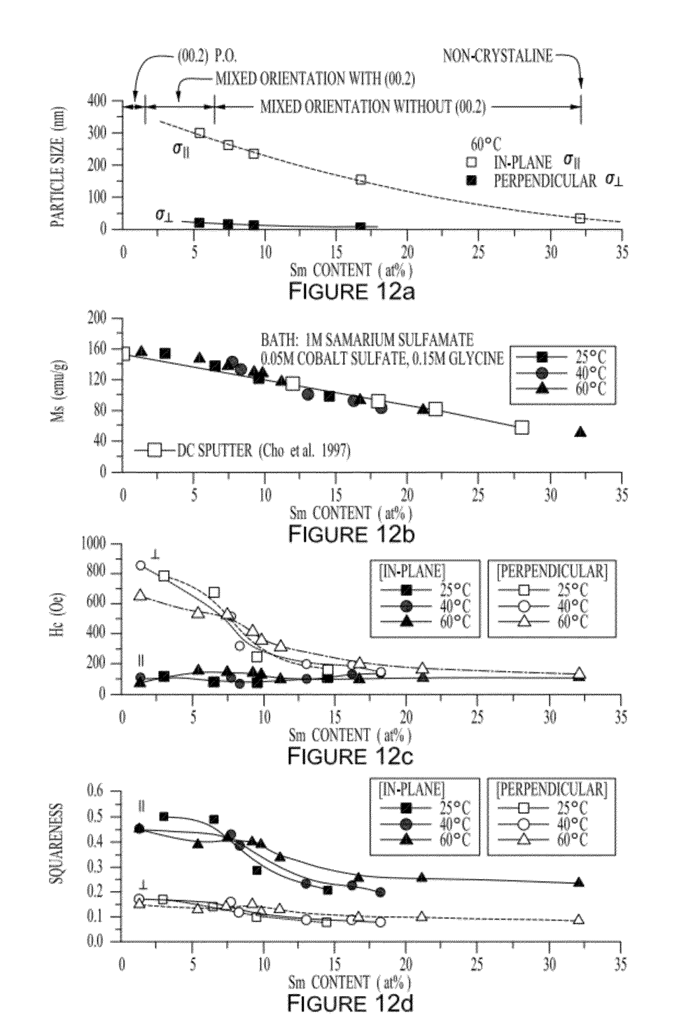

To further quantify the dependence of magnetic properties on alloy composition and deposit characteristics, particle size, crystal structures, Hc, Ms, and squareness of deposits were correlated to Sm content in FIG. 12.

Before heat treatment, deposit characteristics (crystal structure and grain size) for electrodeposited Sm—Co alloys were strongly dependent on Sm deposit content. With increase in Sm deposit content, deposits changed from hcp Co crystallites to non-crystalline structure and grain size decreased, as shown in FIG. 12(a). Ms was dependent on alloy composition. Ms decreased linearly with increased Sm deposit content and was in agreement with sputtered films (FIG. 12(b)). Hc decreased sharply in the perpendicular direction but changed little in the in-plane direction with an increase in Sm content; Hc⊥ approached Hc_{∥} when deposits were of a non-crystalline structure (FIG. 12(c)). At 60° C., dependence of coercivities on Sm deposit content (FIG. 12(c)) can be correlated to crystal structure and particle size (FIG. 12(a)).The sharp reduction in Hc⊥ with increased Sm content (FIG. 12(c)) can be correlated to the significant decrease in σ_{∥} (FIG. 12(a)). On the other hand, σ⊥ decreased little with increased Sm content resulting in a small change in Hc_{∥}. Larger σ_{∥} than σ⊥ could explain higher Hc⊥ than Hc_{∥} of these deposits. When deposits became non-crystalline, consisting of tiny roundish particles (FIG. 9(i) and FIG. 10(o)), Hc⊥ was closer to Hc_{∥} because of similar σ_{∥} and σ⊥ values. The coercivity of electrodeposited Co—P alloys and Co metal also depend on crystal structure of deposits [K. Miller, M. Sydow and G. Dietz, Magn. Magn. Mater., 53, 269, (1985)]; increasing P content leaded to a change from crystalline to non-crystalline deposits, and coercivity decreased significantly. For electrodeposited SmCo alloys, increased Sm content also resulted in deposits changing from crystalline to non-crystalline (FIG. 12(a)). This can cause the decreased coercivities.

Compared to the squareness of crystalline and non-crystalline sputtered SmCo deposits, crystalline deposits have higher squareness (0.3-0.8) than non-crystalline (−0.2) [C. Prados and G. C. I ladjipanayis. J. Appl. Phys., 83, 6253, (1998)]. Deposits changed from crystalline to non-crystalline structure (FIG. 12(a)) as a result of increased Sm content, indicating reduction in squareness. Magnetic properties of non-crystalline deposits exhibit isotropic over anisotropic (easy and hard axis caused by crystallographic structures no longer exist). Therefore, Hc_{∥} and Hc⊥ (FIG. 12(c)) of a non-crystalline SmCo deposits were quite close. The in-plane and perpendicular Ms were also closer when deposits were non-crystalline (see FIG. 11(c), 25° C. or FIG. 11(i), 60° C.). On the other hand, the in-plane squareness was still higher than perpendicular (FIG. 12(d)), probably because the demagnetization direction is still aligned along the in-plane direction for the reduction of demagnetization energy.

(7) Effect of Glycine

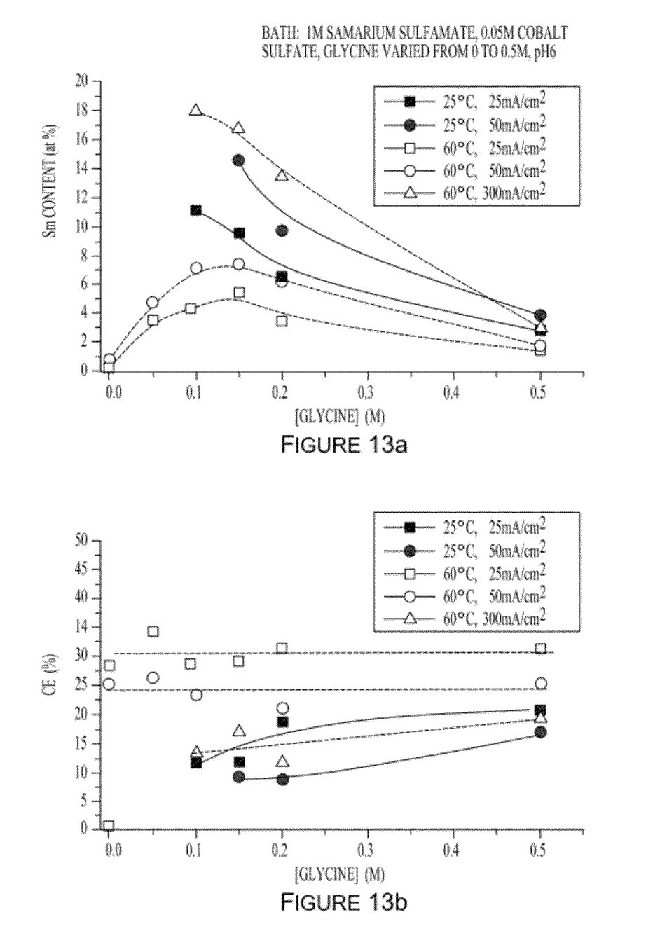

Alloy Composition: Baths consisting of 1M Sm sulfamate, 0.05M Co sulfate and glycine varied from 0.05 to 0.5M were used to study the effect of glycine on deposit properties. Dependence of Sm content and current efficiency on glycine is shown in FIG. 13.

At 25 ° C., low glycine concentrations resulted in non-metallic deposits. Metallic deposits were obtained when glycine concentration was higher than 0.1M at 25 mA/cm² and 0.15M at 50 mA/cm². For metallic deposits obtained at 25° C., Sm deposit content decreased with increasing glycine concentration. At 60° C. and low CDs (25 and 50 mA/cm²), Sm deposit content increased, reached a maximum and then decreased with glycine increased from 0 to 0.5M; highest Sm contents were obtained at 0.15M glycine. With further increase in CD to 300 mA/cm², the highest Sm content was obtained at 0.1M glycine; however, metallic deposits were not observed at glycine concentration below 0.1M. Highest Sm contents were obtained at glycine concentration between 0.1 M (glycine: Co²⁺=2:1) and 0.15M (glycine: Co²⁺=3:1).

(8) Effect of NH₄Sulfamate

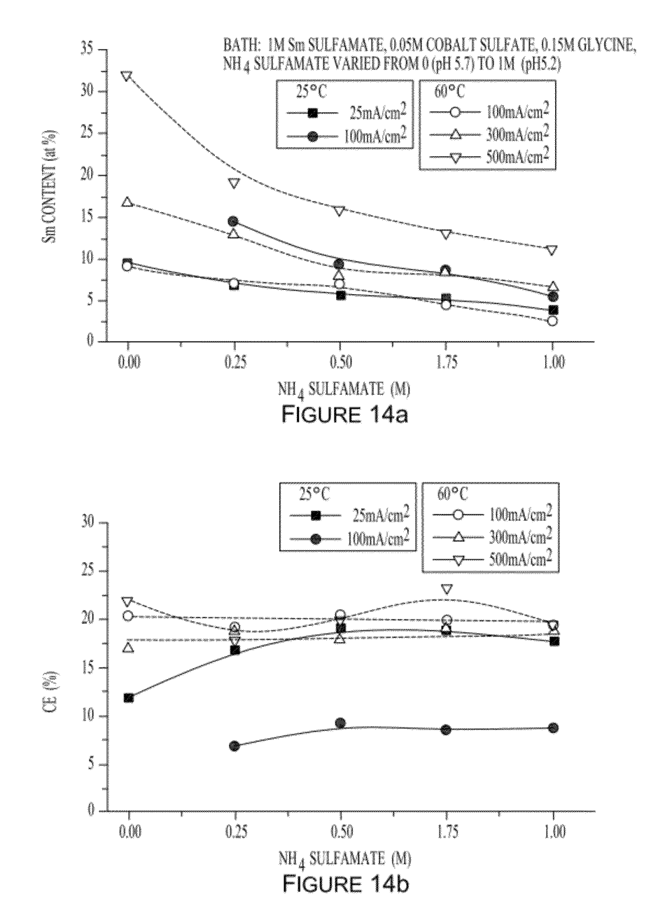

Although addition of NH₄ sulfamate resulted in decreased Sm content, it was of interest to study how NH₄ sulfamate reduced Sm deposit content and affected deposit properties. Baths consisting of 1M Sm sulfamate, 0.05M Co sulfate, 0.15M glycine and NH₄ sulfamate varied from 0 to 1M were used to study the effect of NH₄ sulfamate. Addition of NH₄ sulfamate resulted in decreased Sm content. The decrease in Sm content was more substantial at higher CDs. Increased NH₄ sulfamate concentration suppressed Sm deposition and enhanced Co deposition (FIG. 14).

### C. Aqueous Electrodeposition of Magnetic Sm—Co Alloys—Pulse Current (PC) Electrodeposition Studies

In pulse current (PC) electrodeposition studies, an interrupted cathodic current with square waveform was applied for a specific time period (Tₒₙ) and then returned to ground zero for another specific time period (T_{off}); such a pulse period consisting of Tₒₙ and T_{off} repeats during the electrodeposition. Three important features in PC electrodeposition are: peak current density (PCD), concentration relaxation of reactants and kinetic selected deposition [N. Ibl, J. C. Puippe and H. Angerer, Surf Tech., 6, 287, (1978); N. Ibl, Surf Tech., 10, 81, (1980)]. These characteristics of PC electrodeposition affect alloy compositions and crystal properties of deposits.

Pulse current results in a very high instantaneous peak current density and hence a very negative cathodic potential. Higher CDs or more negative cathodic potentials have been shown to increase Sm deposit content in DC electrodeposition studies. Therefore, PC electrodeposition with high peak current densities can increase Sm deposit content. Furthermore, a very negative cathodic potential increases the nucleation rate, can change the particle size and microstructures of deposits and can enhance deposit magnetic properties.

(1) Effect of PCD and Solution Temperature

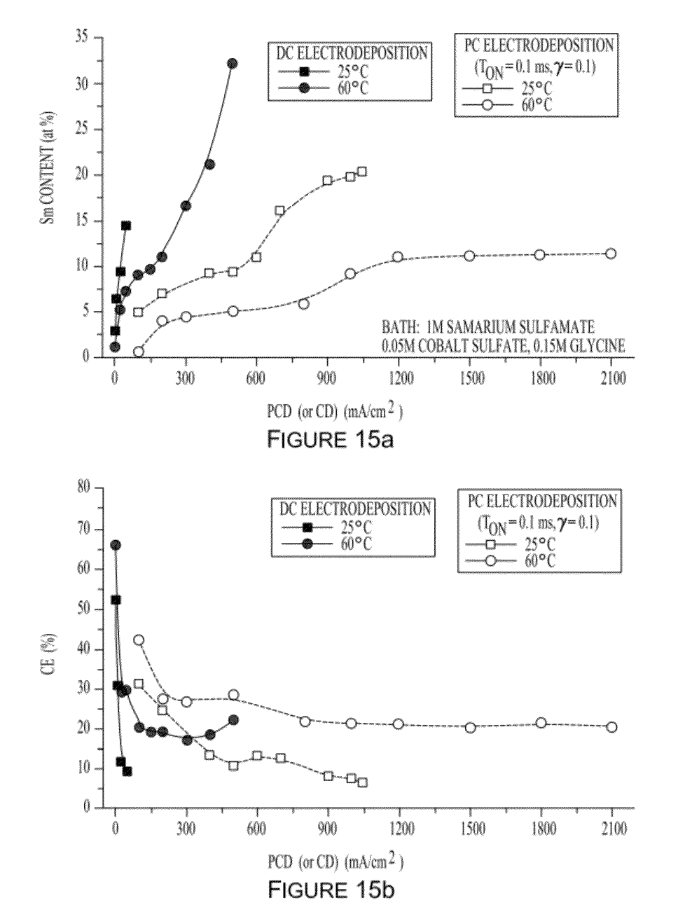

Alloy Composition: Bath 1 was used to study the effects of peak current density (PCD) and solution temperature on alloy properties. Tₒₙ was maintained constant at 0.1 ms and a duty cycle (γ) of 0.1. FIG. 15 compares the effect of PCD (or CD) and solution temperature on Sm deposit content in PC and DC electrodeposition. Similar to DC electrodeposition, increased PCD resulted in increased Sm deposit content. At 25° C., the PCDₘₐₓ of 1050 mA/cm², which was much higher than the CDₘₐₓ of 50 mA/cm², resulted in a higher maximum Sm deposit content (20.3 at %) than by DC (14.5 at %). On the other hand, at 60° C. although the PCDₘₐₓ (2100 mA/cm²) was higher than CDₘₐₓ (500 mA/cm²), maximum Sm content by PC (11.6 at %) was lower than by DC (32.1 at %) due to smaller

$$\frac{d Sm content}{d P C D ( or C D )}$$

of PC electrodeposition. PC electrodeposition at 60° C. resulted in a lower maximum Sm content (11.6 at %) when compared to 25° C. (20.3 at %). On the other hand, DC electrodeposition showed the opposite result of higher maximum Sm content at 60° C. (32.1 at %) than 25° C. (14.5 at %). This confirms the Hull cell studies. Increased PCD led to decreased current efficiency, and elevated solution temperatures resulted in higher current efficiencies in PC electrodeposition.

At 60° C., PC reduced Sm deposition and enhanced Co deposition compared to DC electrodeposition which resulted in lower Sm contents in PC electrodeposition.

(2) Crystal Structures

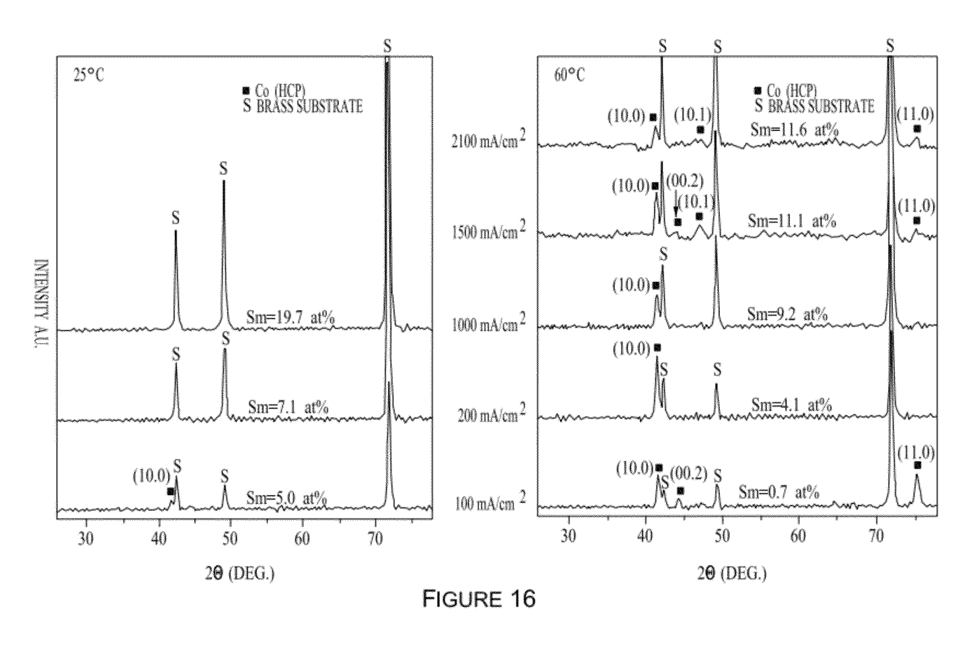

Compared to DC electrodeposition, Sm(OH)₃ was not found in deposits by PC electrodeposition (FIG. 16). DC generates OH— ions continuously during electrodeposition. On the other hand, OH— ions were generated only during Tₒₙ in PC electrodeposition. Therefore, PC electrodeposition resulted in lower OH— ion concentration at the cathode surface and minimizing the formation of Sm(OH)₃ at both 25 and 60° C.

Deposits obtained at 25° C. (FIG. 16, left) appeared non-crystalline for PCD higher than 200 mA/cm². Unlike DC electrodeposition, non-crystalline deposits were not found in PC electrodeposition at 60° C. (FIG. 16, right). All deposits obtained at 60° C. were hcp crystallites, even up to 2100 mA/cm². (00.2), (10.1), (11.0) and (10.0) peaks of hcp Co were observed for deposits.

(3) Magnetic Properties

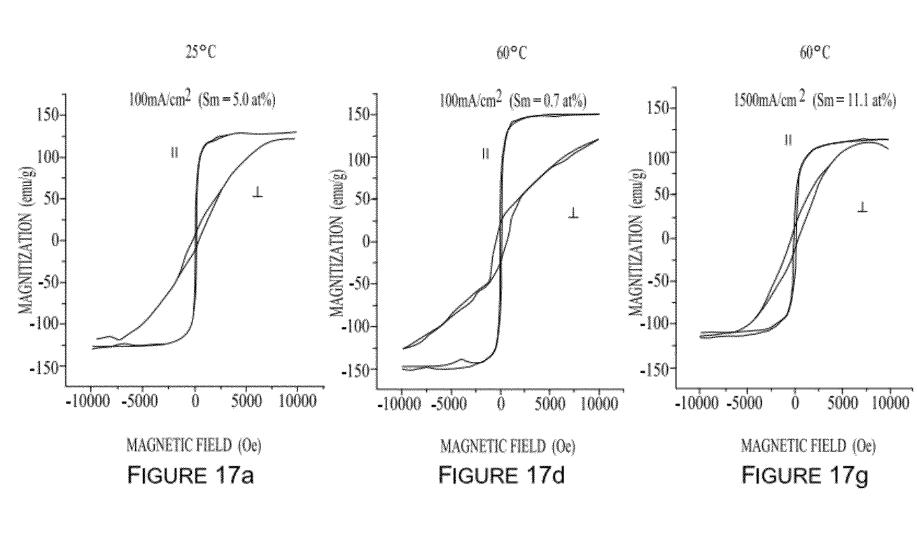

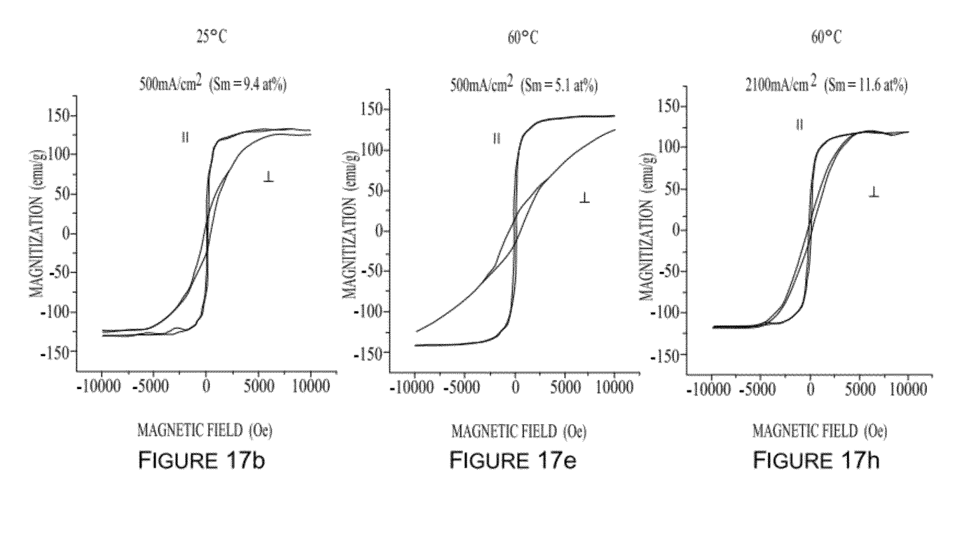

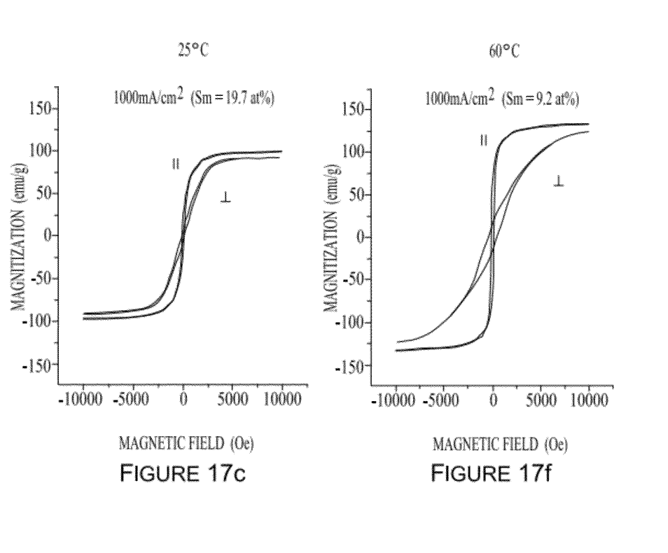

FIG. 17 shows the hysteresis loops of deposits obtained at various PCDs and solution temperatures. Similar to deposits by DC electrodeposition (FIG. 11), magnetization was easier in the in-plane direction than the perpendicular direction indicating the easy-axis (EA) along the in-plane direction and the hard axis (HA) along the perpendicular direction. Hc⊥ was higher than Hc_{∥}. With increased PCD, deposits changed from anisotropic to isotropic magnetic behavior at both 25 and 60° C. Such a change was more significant for deposits obtained at 60° C. Ms and Hc increased as solution temperature increased from 25 to 60° C.

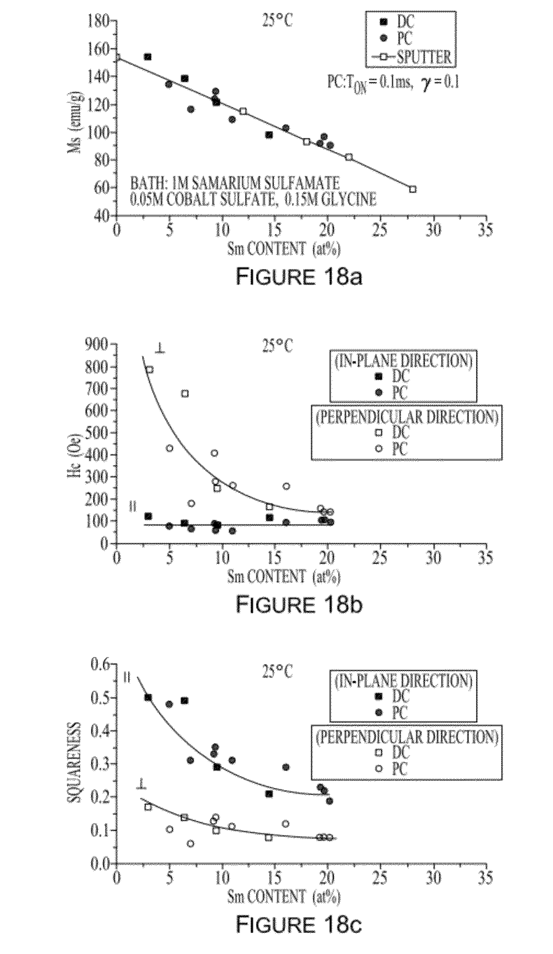

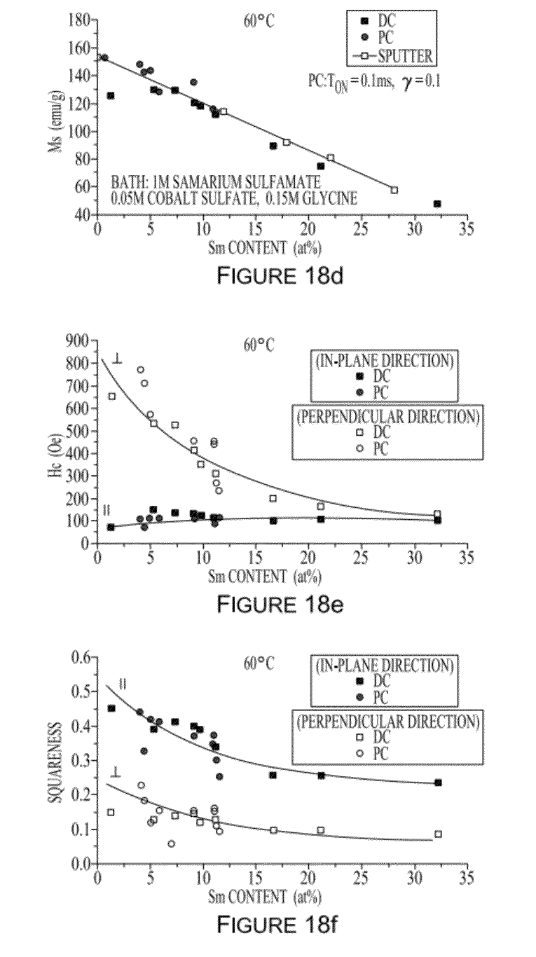

Magnetic properties of deposits by DC and PC electrodeposition are compared in FIG. 18. The strong dependence of magnetic properties of deposits on Sm content was similar to DC electrodeposition. Increased Sm content caused decreased Hc⊥ but Hc_{∥} varied little (FIGS. 18(b) & (e)). Hc⊥ declined and approached Hc_{∥} with increased Sm content. S_{∥} was higher than S⊥ confirming the aligning of the easy axis of magnetization along the in-plane direction (FIGS. 18(c) & (f). It is believed that decreased S_{∥} and S⊥ with increased Sm content was due to the increased non-crystallinity of deposits.

(4) Effect of Duty Cycle

Alloy Composition: Bath 1 was used to study the effects of duty cycle on alloy properties with Tₒₙ=0.1 ms, PCD=200 or 500 mA/cm². An increase in duty cycle (γ) increased Sm content linearly at 25° C. and parabolically at 60° C. Increased Sm content was more significant at the lower solution temperature (25° C.) and higher PCD (500 mA/cm²). On the other hand, increased γ resulted in exponentially decreasing current efficiencies. The decrease was more significant for deposit obtained at 25° C. than at 60° C.

Increased γ did not enhance the deposition of Sm but considerably suppressed the deposition of Co leading to increased Sm deposit content. Increased γ (decreased T_{off}) caused a lower Co concentration at the cathode surface because less Co ions recovered from bulk solution for shorter T_{off}, resulted in the decrease of Co deposition.

(a) Crystal Structures, Morphologies and Microstructures

Increased γ resulted in increased Sm content and changed deposits from crystalline to non-crystalline structures at both 25 and 60° C. Increased γ also induced more microcracks in deposits at both 25° C. and 60° C.

(b) Magnetic Properties

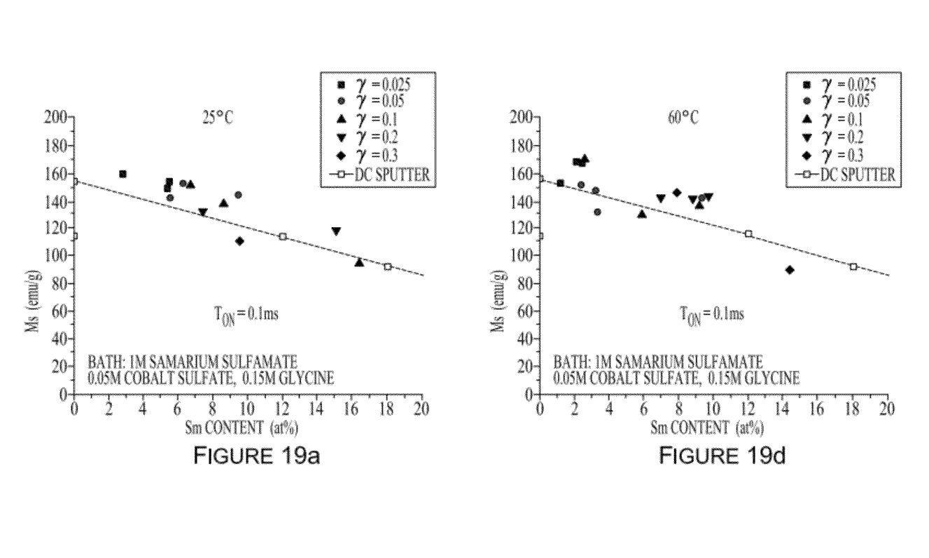

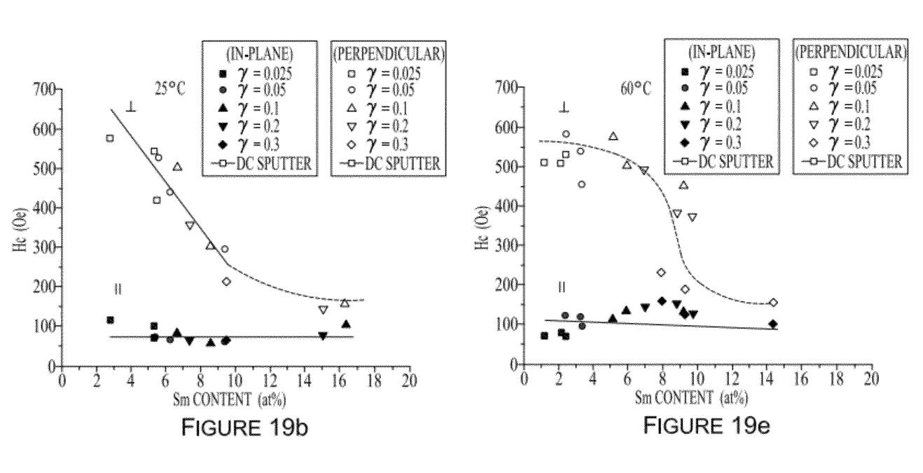

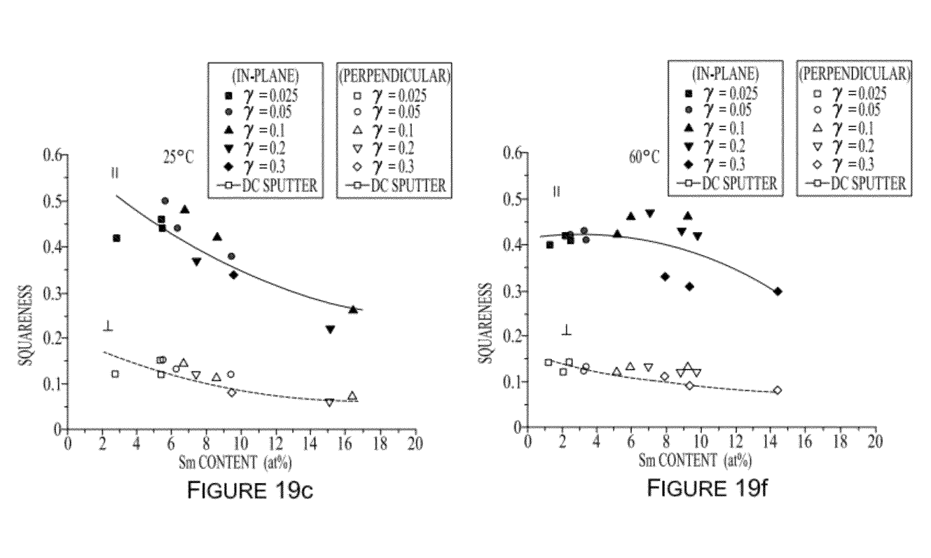

FIG. 19 shows the magnetic properties of deposits obtained at various γ. Similar to the previous observation (effect of PCD and solution temperature on magnetic properties), magnetic properties of deposits obtained at various γ can be correlated to their Sm content which controlled the crystal structure and particle size. Ms values decreased with increased Sm content. Ms obtained from various γ (0.025-0.3) at both 25 and 60° C. were in agreement with sputtered films [H. S. Cho, J. R. Salem, A. J. Kellock and R. B. Beyers, IEEE Trans. Magnetics, 33, 2890, (1997)]. Hc⊥ was higher than Hc_{∥}. Increased Sm content decreased Hc⊥ but Hc_{∥} varied little (FIGS. 19(b) & (e)). Hc⊥ obtained at 25° C. decreased linearly with increasing Sm content, but at 60° C. Hc⊥ decreased gradually for Sm content less than 8 at % then dropped sharply. S_{∥} was higher than S⊥. Both S_{∥} and S⊥ decreased with increased Sm content (FIGS. 19(c) & (f).

5. Effect of Frequency

(a) Crystal Structures and Morphologies

With increased frequency, deposits obtained at 100 mA/cm² and 25° C. changed from non-crystalline to crystalline probably due to decreased Sm content. At low frequencies (100 Hz, 7.1 at % Sm), characteristic peaks for crystallites were not found indicating non-crystalline deposits. At medium frequencies (200-1 k Hz, 6.1-4.7 at % Sm), crystallites of mixed (10.0) and (11.0) peaks were observed. At high frequencies (2 kHz, 1.7 at % Sm), there was a strong (00.2) peak. Deposits obtained at 25° C. and frequencies between 100 and 1 kHz had similar morphologies. Microcracks were present in these deposits.

(b) Magnetic Properties

Ms values decreased linearly with increased Sm content and are in agreement with sputtered films [H. S. Cho, J. R. Salem, A. J. Kellock and R. B. Beyers, IEEE Trans. Magnetics, 33, 2890, (1997)1 in the frequency range between 100 and 2,000 Hz. Increased Sm content decreased Hc⊥ but He varied little. Although both S_{∥} and S⊥ decreased with increased Sm content (FIG. 19(d)), the decrease was less significant compared to the effect of PCD and solution temperature) and duty cycle.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition for aqueous electrodeposition of samarium-cobalt alloys having a samarium content or greater than 20% and less than about 35% comprising: a water soluble salt of samarium, a water soluble salt of cobalt, and a complexant.

2. The composition of claim 1, wherein the water soluble salt of samarium is samarium sulfamate.

3. The composition of claim 1, wherein the water soluble salt of cobalt is cobalt sulfate or cobalt sulfamate.

4. The composition of claim 1, wherein the complexant is selected from the group consisting of one or more of glycine, its derivatives, amine or amino carboxylates, one or more hydroxycarboxylic acids, and combinations thereof.

5. The composition of claim 1, further comprising one or more supporting electrolytes selected from the group consisting of ammonium sulfamate, ammonium sulfate, and mixtures thereof.

6. The composition of claim 1, comprising from about 0.25M to about 2.0M of the water soluble salt of samarium, from about 0.01M to about 0.5M of the water soluble salt of cobalt, from about 0.05M to about 0.5M of the complexant and optionally up to about 3M of one or more supporting electrolytes.

7. The composition of claim 6, comprising about 1M of the water soluble salt of samarium, about 0.05M of the water soluble salt of cobalt, about 0.15M of the complexant, and about 1M of the one or more supporting electrolytes.

8. A method for electrodepositing a samarium-cobalt coating onto a conducting substrate, said coating having a samarium content or greater than 20% and less than about 35%, comprising:
a. placing an aqueous solution containing a water soluble salt of samarium, a water soluble salt of cobalt and a complexant into a plating bath, said plating bath optionally including a supporting electrolyte,
b. placing an anode and the substrate to be coated into the bath and connecting the anode and the substrate to a power supply, with the substrate acting as a cathode,
c. adjusting the pH and temperature of the bath to a suitable operating level, and
d. applying a current through the anode and substrate sufficient to cause the samarium and the cobalt to deposit on and adhere to the substrate.

9. The method of claim 8, wherein the water soluble salt of samarium is samarium sulfamate and the water soluble salt of cobalt is cobalt sulfate or cobalt sulfamate.

10. The method of claim 8, wherein the complexant is selected from one or more of glycine, its derivatives, amine or amino carboxylates, one or more hydroxycarboxylic acids, and combinations thereof.

11. The method of claim 8 wherein the optional supporting electrolyte is ammonium sulfamate, ammonium sulfate or mixtures thereof.

12. The method of claim 8, wherein the aqueous solution comprises from about 0.25M to about 2.0M of the water soluble salt of samarium, from about 0.01M to about 0.5M of the water soluble salt of cobalt, from about 0.05M to about 0.5M of the complexant, and optionally up to about 3M of the supporting electrolytes.

13. The method of claim 8, wherein the aqueous solution comprises about 1M of the water soluble salt of samarium, about 0.05M of the water soluble salt of cobalt and about 0.15M of the complexant.

14. The method of claim 8, wherein a current density of from about 5 mA/cm² to about 600 mA/cm² is applied across the anode and cathode.

15. The method of claim 8, wherein the applied current is a pulsed current, a duty cycle and frequency of the pulsed current being selected to obtain desired deposit characteristics.

16. The method of claim 8, wherein the pH of the solution is from about 4 to about 6.5.

17. The method of claim 8, wherein the solution temperature is from about 25° C. to about 80° C.

18. A samarium-cobalt coating having a samarium content of greater than 20% and less than about 35% produced by the method of claim 8.

19. An electrodeposited nanostructured magnetic coating on a substrate, said coating comprising a magnetic alloy of a rare earth metal and a transition metal, said magnetic alloy having a samarium content or greater than 20% and less than about 35%, said nanostructured magnetic coating being electrodeposited on the substrate from an aqueous solution.

20. The nanostructured magnetic coating of claim 19, wherein the alloy comprises SmCo₅ or Sm₂CO₁₇.
